(19) United States
(12) Patent Application Publication
(10) Pub. No.: US 2014/0094974 A1
(43) Pub. Date: Apr. 3, 2014

(54) LIFT AND CHOKE CONTROL

(71) Applicant: Schlumberger Technology Corporation, Sugar Land, TX (US)

(72) Inventor: Kashif Rashid, Newton, MA (US)

(73) Assignee: Schlumberger Technology Corporation, Sugar Land, TX (US)

(21) Appl. No.: 14/038,859

(22) Filed: Sep. 27, 2013

Related U.S. Application Data
(60) Provisional application No. 61/708,231, filed on Oct. 1, 2012.

(51) Int. Cl. G05D 7/06

(52) U.S. Cl. CPC G05D 7/0617
USPC 700/282

(57) ABSTRACT

A method can include selecting two control variables for a fluid production network; providing data acquired from the production network, the data associated with values for the two control variables; providing an interpolation model for interpolating the data over a domain defined by operational bounds for each of the two control variables; and solving a programming problem based at least in part on the interpolation model to provide values for at least one of the two control variables. Various other apparatuses, systems, methods, etc., are also disclosed.

### RELATED APPLICATIONS

This application claims the benefit of U.S. Provisional Patent Application Ser. No. 61/708,231, filed 1 Oct. 2012, which is incorporated by reference herein.

### BACKGROUND

Production of material (e.g., water, hydrocarbons, etc.) from wells may be formulated as a network. A production technique may employ a lift mechanism to accelerate production and a choke mechanism to restrain production. As an example, each well or groups of wells may employ one or more such mechanisms. Various techniques described herein pertain, for example, to production networks.

### SUMMARY

A method can include selecting two control variables for a fluid production network; providing data acquired from the production network, the data associated with values for the two control variables; providing an interpolation model for interpolating the data over a domain defined by operational bounds for each of the two control variables; and solving a programming problem based at least in part on the interpolation model to provide values for at least one of the two control variables. A system can include a field controller that includes data acquisition instructions; a field network that includes equipment controllable by the field controller; and a modeler that includes offline instructions and online instructions where the offline instructions includes instructions for an interpolation model for modeling data acquired by the field controller for at least two control variables for equipment controllable by the field controller. One or more computer-readable media can include computer-executable instructions to instruct a computer to: solve a programming problem based in part on an interpolation model for data of a fluid production network with respect to control variables of the fluid production network to provide values for at least one of the control variables of the fluid production network.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example field system that includes various components, an example of a method and an example of a device or system;

FIG. 2 illustrates an example of a system;

FIG. 3 illustrates an example of a graph;

FIG. 4 illustrates an example of a method;

FIG. 5 illustrates an example of a method;

FIG. 6 illustrates an example of a system;

FIG. 7 illustrates examples of graphs;

FIG. 8 illustrates a table associated with examples corresponding to the graphs of FIG. 3 and FIG. 7;

FIG. 9 illustrates an example of a plot of production versus gas lift;

FIGS. 10 and 11 illustrate a series of plots;

FIGS. 12 and 13 illustrate a series of plots;

FIGS. 14 and 15 illustrate a series of plots;

FIGS. 16 and 17 illustrate a series of plots;

FIGS. 18 and 19 illustrate a series of plots;

FIGS. 20 and 21 illustrate a series of plots;

FIG. 22 illustrates a series of plots;

FIG. 23 illustrates a series of plots;

FIG. 24 illustrates a series of plots;

FIG. 25 illustrates a series of plots; and

FIG. 26 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As an example, a method may include a programming problem that may help optimize a large-scale gathering system (e.g., a physical production network), for example, given an objective function and control modes for various production wells where a solution may involve implementing an interpolation scheme and, for example, a well deactivation procedure. In such an example, gas-lift rate and choke setting may be assigned as control variables in various well (e.g., to determine control modes). As an example, an increase in gas-lift rate may increase well flowrate while choke may be used to reduce well flowrate. As an example, choke can be beneficial where well and field level constraints are desired to be met or, for example, to deactivate a well, that may have high water production, by implementing a zero choke setting. As an example, a deactivation procedure may be employed if a solution to a relaxed programming problem is below a minimum desired choke setting imposed for stability purposes.

As an example, a method can include selecting two control variables for a fluid production network; providing data acquired from the production network, the data associated with values for the two control variables; providing an interpolation model for interpolating the data over a domain defined by operational bounds for each of the two control variables; and solving a programming problem based at least in part on the interpolation model to provide values for at least one of the two control variables.

As an example, a programming problem may be a nonlinear programming problem, a mixed-integer nonlinear programming problem or a mixed-integer linear programming problem. As an example, a programming problem may include solving an optimization problem defined by a system of equalities and inequalities (e.g., collectively constraints) over a set of unknown real variables, along with an objective function to be maximized or minimized. In such a programming problem, one or more constraints and/or an objective function may be nonlinear. A mixed-integer programming problem may be a linear programming problem where, for example, the problem involves minimization or maximization of a linear function subject to linear constraints. As an example, a mixed-integer nonlinear programming problem may include continuous and discrete variables and nonlinearities in an objective function and/or constraints. As an example, a programming problem may be classified according to its computational complexity (e.g., according to computational complexity theory).

As an example, a branch and bound approach may be applied to a problem (e.g., for deactivation, etc.). For example, sub-problems may be created by restricting the range of integer variables. As an example, for binary variables, possible restrictions may be 0 and 1. As an example, a variable with a lower bound l and upper bound u may be divided into two problems with ranges l to q and q+1 to u, respectively. In such an example, lower bounds may be provided by linear-programming relaxation (e.g., by keeping the objective function and constraints and relaxing integrality restrictions to derive a linear program). As an example, where an optimal solution to a relaxed problem is (coincidentally) integral, it may be deemed to be an optimal solution to the sub-problem and the value may be used to terminate searches of sub-problems whose lower bound is higher.

As an example, in a network model, an artificial lift mechanism may include gas-lift where an allocated quantity is based on a total amount of lift-gas available. Various examples that include artificial lift may include modeling horsepower to ESP pumps, stimulant allocation or some other quantity of interest, for example, retaining chokes as a second control mode to manage well and field-wide constraints by controlling the rate of fluid flow in a given well.

As an example, various methods may implement a gas-lift optimization (GLO) methodology, for example, based on an iterative offline-online procedure. Such a methodology may enable a solution to a network optimization problem to be achieved efficiently using a minimal number of real network simulation evaluations.

As an example, a method may include implementing an iterative offline-online solution approach. In such an example, an offline model may be represented with data gathered in a pre-processing stage. As an example, an offline model may include a number of dependent variables. In various examples, two dependent variables are selected (e.g., for gas-lift and choke). As an example, an interpolation scheme may be employed, for example, to map a variable space to an objective space. As an example, an interpolation scheme (e.g., interpolation model) may be a bilinear interpolation scheme. As an example, a mathematical formulation may be a programming problem formulation (e.g., nonlinear programming problem, mixed-integer nonlinear programming problem, mixed-integer linear programming problem, etc.).

Various trials demonstrate that a programming problem formulation may expedite output of a solution, which may be, for example, optionally implemented in near-real time for a physical network of equipment. As an example, a deactivation procedure may be employed, for example, to deactivate wells, equipment, etc. Such a procedure may be implemented, for example, using a branch and bound solver or, for example, using a sub-set space thereof, which may expedite output of a solution (e.g., a well shut down procedure). As an example, an optimization problem may be solved to provide output in a manner that allows for near real-time implementation (e.g., production control) of a physical production network (e.g., a gathering system for a resource or resources).

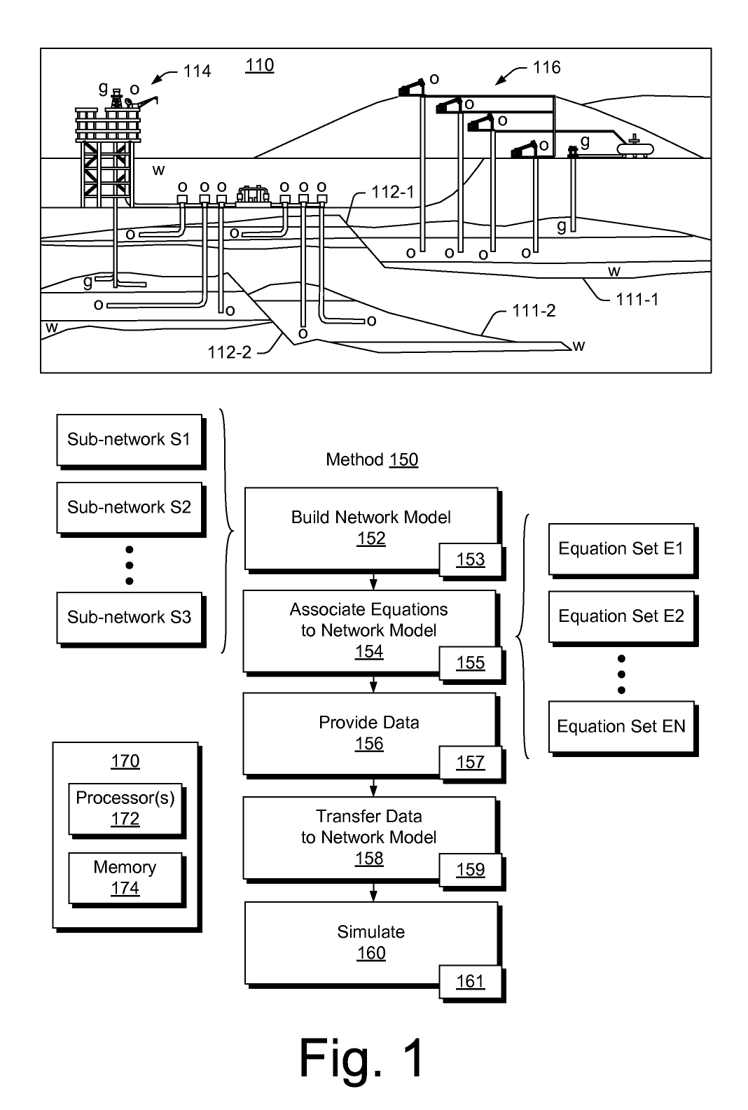

FIG. 1 shows an example of a geologic environment 110 that includes reservoirs 111-1 and 111-2, which may be faulted by faults 112-1 and 112-2, an example of a method 150 and an example of a device or system 170. FIG. 1 also shows some examples of offshore equipment 114 for oil and gas operations related to the reservoirs 111-1 and 111-2 and onshore equipment 116 for oil and gas operations related to the reservoir 111-1.

As an example, a model may be generated that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead (e.g., production), from a wellhead to a reservoir (e.g., injection), etc. A flow simulation model may also include equations that account for flowline and surface facility performance, for example, to perform a production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc.

As an example, a system may provide for transportation of oil and gas fluids from well locations to processing facilities. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas-lift analysis, erosion analysis, corrosion analysis, production analysis, injection analysis, etc. In such an example, one or more analyses may be based, in part, on a simulation of flow in a modeled network. As an example, an analysis may include plotting inflow and outflow of fluid at a nodal point or nodal points in the system, which may indicate where certain opportunities exist (e.g., for injection, for production, etc.).

A modeling framework may include modules to facilitate generation of a flow simulation model. For example, a module may provide for modeling completions for vertical wells, completions for horizontal wells, completions for wells coupled to hydraulic fractures, etc. A modeling framework may include modules for particular types of equations, for example, black-oil equations, equation-of-state (EOS) equations, etc. A modeling framework may include modules for artificial lift, for example, to model fluid injection, fluid pumping, etc. As an example, consider a module that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to the method 150 of FIG. 1, it can include a build block 152 for building a network model that represents a production system for fluid; an association block 154 for associating equations with sub-networks in the network model (e.g., to represent features of the network model mathematically), a provision block 156 for providing data; a transfer block 158 for transferring the data to the network model; and a simulation block 160 for simulating physical phenomena associated with the production system using the network model to provide simulation results, for example, by solving a system of equations.

The method 150 is shown in FIG. 1 in association with various computer-readable media (CRM) blocks 153, 155, 157, 159 and 161. Such blocks generally include instructions suitable for execution by one or more processors (or processing cores) 172 to instruct the computing device or system 170 to perform one or more actions. While various blocks are shown, a single medium may be configured with instructions to allow for, at least in part, performance of various actions of the method 150. As an example, a computer-readable medium (CRM) may be a computer-readable storage medium, for example, such as a memory device 174 of the computing device or system 170, where the memory device 174 includes memory.

A production system can include equipment, for example, where a piece of equipment of the production system may be represented in a sub-network of a network model (e.g., via mathematical equations, etc.). As an example, a piece of equipment may include a gas-lift valve or a series of gas-lift valves (e.g., to inject gas from a well casing into production tubing of the well). As an example, a piece of equipment may include a choke, for example, to control flow of fluid in a well (e.g., from a well to a surface location, etc.). As an example, a piece of equipment may include an electric motor operatively coupled to a mechanism to move fluid (e.g., a pump, compressor, etc.). As an example, a piece of equipment may include a heater coupled to a power source, a fuel source, etc. (e.g., consider a steam generator). As an example, a piece of equipment may include a conduit for delivery of fluid where the fluid may be for delivery of heat energy (e.g., consider a steam injector). As an example, a piece of equipment may include a conduit for delivery of a substance (e.g., a chemical, a proppant, etc.).

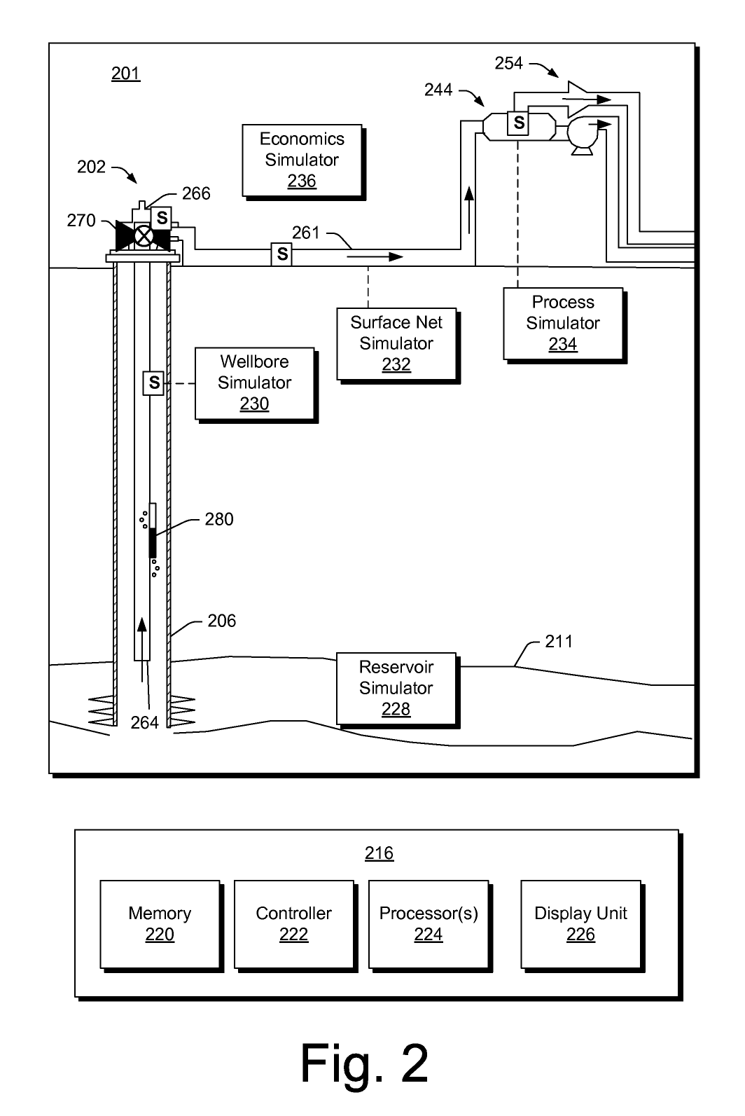

FIG. 2 shows an example of a schematic view of a portion of a geologic environment 201 that includes equipment. As shown in FIG. 2, the environment 201 includes a wellsite 202 and a network 244. The wellsite 202 includes a wellbore 206 extending into earth as completed and prepared for production of fluid from a reservoir 211.

In the example of FIG. 2, wellbore production equipment 264 extends from a wellhead 266 of the wellsite 202 and to the reservoir 211 to draw fluid to the surface. As shown, the wellsite 202 is operatively connected to the network 244 via a transport line 261. As indicated by various arrows, fluid can flow from the reservoir 211, through the wellbore 206 and onto the network 244. Fluid can then flow from the network 244, for example, to one or more fluid processing facilities.

In the example of FIG. 2, equipment can include one or more of a choke equipment 270 (e.g., a choke) and gas-lift equipment 280 (e.g., gas-lift valve, etc.). As an example, a choke may include an orifice that may be fixed or adjustable, for example, to control fluid flow rate, downstream pressure, etc. An adjustable choke may enable fluid flow and pressure parameters to be selectively adjusted, for example, to suit process or production requirements. As an example, a choke may be or include a valve, for example, located on or near a Christmas tree that is used to control the production of fluid from a well. Opening or closing the variable valve may influence rate and pressure at which production fluids progress (e.g., through a pipeline, process facility, etc.). As an example, an adjustable choke may be linked to a controller (e.g., a control system) that may allow for production parameters of an individual well, a gang of wells, etc. to be controlled.

As an example, gas-lift may be implemented as an artificial-lift technique in which gas is injected into production tubing, for example, to reduce hydrostatic pressure of a fluid column. As an example, a resulting reduction in bottomhole pressure may allow reservoir fluid to enter a wellbore at a higher flow rate. As an example, injection gas may be conveyed down a tubing-casing annulus and enter a production train through one or more gas-lift valves. As an example, gas-lift valve position, operating pressures and gas injection rate may be determined according to particular well conditions.

As an example, a gas-lift valve may be positioned in a mandrel or other equipment. As an example, a mandrel may be a so-called pocket mandrel that may be configured to receive one or more gas-lift valves. Operation of a gas-lift valve may be determined, as an example, according to preset opening and closing pressures (e.g., in tubing, an annulus, tubing and an annulus, etc.).

As an example, during startup, upper gas-lift valves may open in sequence, from the top down, to enable tubing fluids to be displaced. As an example, at predetermined pressures, each upper valve may close to eventually route all lift gas through an operating valve, which may be at an optimal depth for reservoir and completion conditions.

In the example of FIG. 2, sensors (S) are located, for example, to monitor various parameters during operations. The sensors (S) may measure, for example, pressure, temperature, flowrate, composition, and other parameters of the reservoir, wellbore, gathering network, process facilities and/or other portions of an operation. As an example, the sensors (S) may be operatively connected to a surface unit 216 (e.g., to instruct the sensors to acquire data, to collect data from the sensors, etc.).

In the example of FIG. 2, the surface unit 216 can include computer facilities, such as a memory device 220, a controller 222, one or more processors 224, and display unit 226 (e.g., for managing data, visualizing results of an analysis, etc.). As an example, data may be collected in the memory device 220 and processed by the processor(s) 224 (e.g., for analysis, etc.). As an example, data may be collected from the sensors (S) and/or by one or more other sources. For example, data may be supplemented by historical data collected from other operations, user inputs, etc. As an example, analyzed data may be used to in a decision making process.

In the example of FIG. 2, a transceiver (not shown) may be provided to allow communications between the surface unit 216 and one or more pieces of equipment in the environment 201. For example, the controller 222 may be used to actuate mechanisms in the environment 201 via the transceiver, optionally based on one or more decisions of a decision making process. In such a manner, equipment in the environment 201 may be selectively adjusted based at least in part on collected data. Such adjustments may be made, for example, automatically based on computer protocol, manually by an operator or both. As an example, one or more well plans may be adjusted (e.g., to select optimum operating conditions, to avoid problems, etc.).

To facilitate data analyses, one or more simulators may be implemented (e.g., optionally via the surface unit 216 or other unit, system, etc.). As an example, data fed into one or more simulators may be historical data, real time data or combinations thereof. As an example, simulation through one or more simulators may be repeated or adjusted based on the data received.

In the example of FIG. 2, simulators can include a reservoir simulator 228, a wellbore simulator 230, and a surface network simulator 232, a process simulator 234 and an economics simulator 236. As an example, the reservoir simulator 228 may be configured to solve for hydrocarbon flow rate through a reservoir and into one or more wellbores. As an example, the wellbore simulator 230 and surface network simulator 232 may be configured to solve for hydrocarbon flow rate through a wellbore and a surface gathering network of pipelines. As to the process simulator 234, it may be configured to model a processing plant where fluid containing hydrocarbons is separated into its constituent components (e.g., methane, ethane, propane, etc.), for example, and prepared for further distribution (e.g., transport via road, rail, pipe, etc.) and optionally sale. As an example, the economics simulator 236 may be configured to model costs associated with at least part of an operation.

As mentioned, a method may provide for optimizing a large-scale gathering system (see, e.g., equipment of FIG. 1 and FIG. 2) for a stipulated objective function with dual control modes in various production wells using an interpolation scheme with representative data, for example, together with a well deactivation procedure. In such an example, gas-lift rate and choke setting may be assigned as control variables in various well. For example, various wells may include a choke equipment and gas-lift equipment (see, e.g., the equipment 270 and 280 of FIG. 2).

As an example, an increase in gas-lift rate may increase well flowrate, while choke may be used to reduce well flowrate. As an example, choke can be beneficial where well and field level constraints are desired to be met or, for example, to deactivate a well with high water production with a zero choke setting (e.g., consider closing a valve of the choke equipment 270 of FIG. 2). As an example, a deactivation procedure may be employed if a solution to a relaxed programming problem is below a minimum desired choke setting imposed for stability purposes.

As an example, where variables include a gas-lift rate variable and a choke variable, these two variables may be represented in a two-dimensional space (e.g., in a 2D graph, a plane, etc.). As an example, these two variables may define a surface of a given property of interest, such as the oil production rate. As an example, more than two variables may be used in a mathematical formulation. As an example, one or more formulations may be provided. For example, consider formulations for phases of a multiphase fluid (e.g., oil, water and gas). Various properties may be considered in a mathematical formulation where such properties are germane to operation of a network (e.g., a physical network). As an example, a larger economic formulation may include a variety of property-based formulations. While various examples mention two variables, which may be opposed (e.g., acceleration and deceleration, etc.), variables may be complementary or otherwise related (e.g., correlated, etc.).

As an example, a 2D graph may represent a bilinear interpolation model optionally with well deactivation for a given well, for example, where an x-axis represents gas-lift rate (L) and a y-axis represents choke setting (C) (e.g., as control variables in various wells). In such an example, lower and upper bounds may be defined by a minimum and a maximum for each control variable. Points corresponding to control variables in such a 2D graph may correspond to production data, for example, as obtained in a pre-processing process of a gas-lift optimization (GLO) methodology. For example, a production value (Q) may be given as a function of L and C for a particular wellhead pressure (P). In such an example, the production value may be represented with respect to a third axis, thereby providing a 3D graph or surface of the selected property. For example, production value may be a liquid rate, an oil rate or another physical production value, which may be of engineering, economic, engineering and economic, etc., concern.

As an example, data may be modeled using bilinear interpolation for individual wells for a number of wells in a network model. In such an example, curve fitting or model approximation may be avoided.

As an example, a resulting programming problem that defines an offline problem may be solved to provide a solution and if the solution of a continuously relaxed problem (e.g., one that ignores a lower bound on a choke setting) lies in a region (e.g., represented by a control variable graph), a proposed well deactivation procedure may be applied.

In a graphical representation, a circle may be positioned at an intersection of axes to represent a deactivated well state, for example, with zero choke setting and zero gas-lift rate.

As an example, an online-offline GLO methodology may resume once an offline solution is feasible after a number of deactivation steps (e.g., a solution in which each well is subsequently active over a feasible region or deactive, and no solutions exist in a defined region below a minimum choke value).

As an example, a deactivation procedure may serve to address well and field level constraints that cannot be met by simply choking wells back and also to impart greater model robustness with respect to an online-offline procedure (e.g., to impart greater well stability by preventing supersonic flow).

Various mathematical formulations are presented herein, of which the aforementioned bilinear interpolation scheme with well deactivation is demonstrated as being effective and efficient for treating large-scale production system of many variables in near real-time (e.g., as achieved with a fast offline solution together with a minimal number of network evaluations).

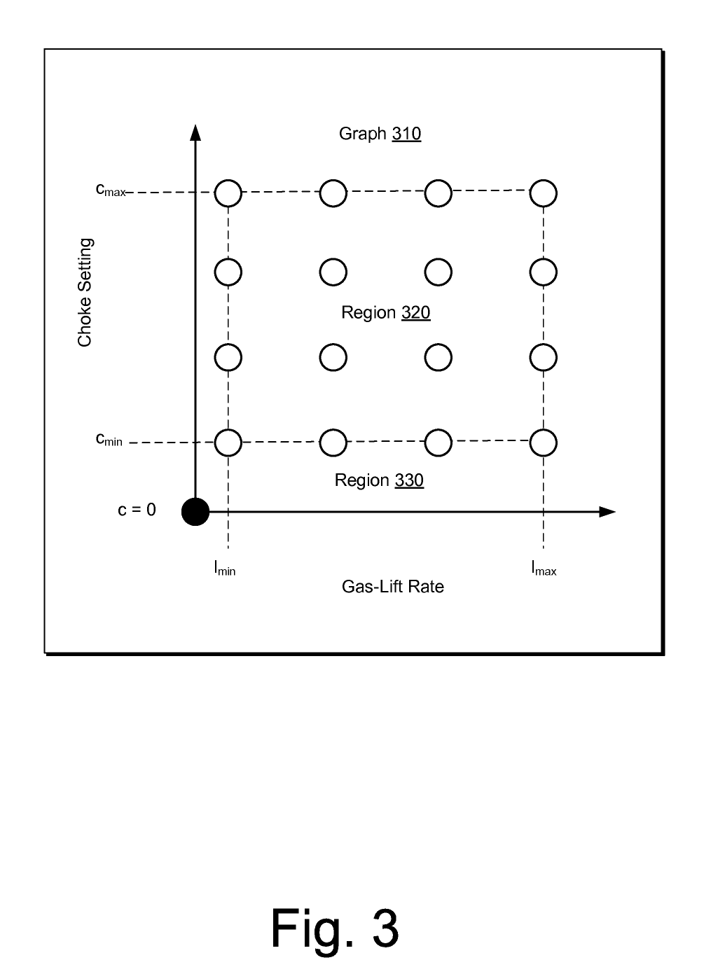

FIG. 3 shows an example of a graph 310 that includes a control variable “l” and a control variable “c”. Points are indicated by open circles that span a region 320 between minimum and maximum values for the control variables. A region 330 is also shown, which lies below a minimum value for the control variable “c”.

As an example, a resulting programming problem that defines an offline problem may be solved to provide a solution and if the solution of a continuously relaxed problem (e.g., one that ignores a lower bound on a choke setting) lies in the region 330 (e.g., represented by a control variable graph), as an example, a well deactivation procedure may be applied. For example, the region 330 may represent a well deactivation region.

In a graph 310 of FIG. 3, a filled-circle is positioned at an intersection of axes to represent a deactivated well state, for example, a well state with zero choke setting and zero gas-lift rate (e.g., where “c” is choke and “l” is gas-lift).

As an example a GLO method may be implemented to solve a large-scale gas-lift optimization problem. For example, wells in a gathering network model may be decoupled under the assumption of separability at prevailing wellhead pressures. In such an example, a family of lift curves may be extracted for each well in a preprocessing procedure and used to construct an approximate (e.g., offline) model that may be optimized in place of a network simulation. In such an example, an offline solution may subsequently be applied to an actual (e.g., online) network, for example, to account for effects of well interdependence and in so doing, to establish updated wellhead pressures. As an example, a process may be repeated iteratively until one or more convergence conditions have been met.

As an example, a GLO method may include the following processes:

0A: Establishing a family of well performance curves for each well as a preprocessing process.

0B: Running the network model once to establish an initial wellhead pressure (WHP) distribution vector (Pⁱⁿⁱ).

0C: Setting an iteration counter k=1 and Pₖ=Pⁱⁿⁱ, where P is vector of wellhead pressures (WHP).

1: Setting operating curve data for each well at a desired wellhead pressure estimate (Pₖ).

2: Solving an approximate (e.g., offline) problem to obtain a solution vector (X).

3: Evaluating the network model at X to obtain an updated wellhead pressure vector (Pₖ₊₁).

4: Performing a convergence test based on the norm of the current and updated wellhead pressure vectors, ε=∥Pₖ₊₁, Pₖ∥.

5A: If ε>εₜₒₗₛ: setting Pₖ=Pₖ₊₁ and k=k+1; and returning to 1.

5B: If ε≦εₜₒₗₛ: returning the solution (X, P, Q, F); and terminating the method (e.g., where X, P and Q are vectors of lift-gas, wellhead pressure and flowrate and where F is the objective function value).

As an example, an interpolation approach may be implemented as to the process 2 above (e.g., one or more offline processes). As mentioned, in a model with two control variables, as an example, one variable may be for gas-lift and the other variable may be for choke. As to interpolation, as an example, a bilinear interpolation may be implemented that spans two control variables (e.g., over specified bounds). In such an example, a bilinear interpolation model may be defined based on well data Dᵢ for a wellhead pressure pᵢ where an index “i” represents a particular well number from a total number of controllable wells.

As a more particular example for a bilinear interpolation model, consider the following equations:

$$max {\sum }_{i = 1}^{n} {q}_{i} = {\sum }_{i = 1}^{n} B ( {1}_{i} , {c}_{i} \vert {D}_{i} , {p}_{i} )$$

$$s . t . , {\sum }_{i = 1}^{n} {1}_{i} \leq {C}_{g}$$

$${1}_{i}^{min} \leq {1}_{i} \leq {1}_{i}^{max}$$

$${c}_{i}^{min} \leq {c}_{i} \leq {c}_{i}^{max}$$

$${q}_{i} \leq {q}_{con , i}^{well}$$

$${\sum }_{i = 1}^{n} {q}_{i} \leq {q}_{con}^{field}$$

$$∀ i ∈ I$$

In the foregoing equations, lᵢ and cᵢ are the gas-lift and choke setting variables in well i over the set I of controllable wells, with bounds specified by lower and upper values, respectively. In the foregoing equations, B(lᵢ, cᵢ|Dᵢ, pᵢ) defines a bilinear interpolation model based on well data Dᵢ at the prevailing wellhead pressure pᵢ. For network simulation stability, cₘᵢₙ>0 and desirably, above a minimum choke setting to help ensure well stability (e.g., but could be set to zero in an offline optimization problem, potentially accounting for well activation). The “such that” (i.e., s.t.) equation defines the available gas limit (C_{g}) constraint, while other equations define production limits at well and field level, respectively. The foregoing model has 2n variables, where n is the number of wells that represent the gas-lift rate (l) and choke setting (c) in each well. The graph 310 of FIG. 3 may represent an offline bilinear interpolation model akin to that of the foregoing equations.

As mentioned, interpolations other than bilinear may be implemented to provide lines, surfaces, equations, etc. For example, in the context of wells, lines, surfaces, equations may be defined for well data Dᵢ at corresponding wellhead pressure pᵢ with respect to a region defined by one or more control variables. In particular, for a two control variable example, lines (e.g., optionally curves) may exist for each wellhead pressure where one or more of the variables is limited to or desired to be operated at discrete states. For example, consider a choke with six discrete operational states (e.g., 0, 0.2, 0.4, 0.6, 0.8 and 1.0). In such an example, a model that models information for those states may be relevant and be defined to expedite computation time (e.g., compared to a full surface approach). For example, a number of curves may exist for each discrete choke state for each wellhead pressure where each curve spans, at least in part, a range for a gas-lift variable.

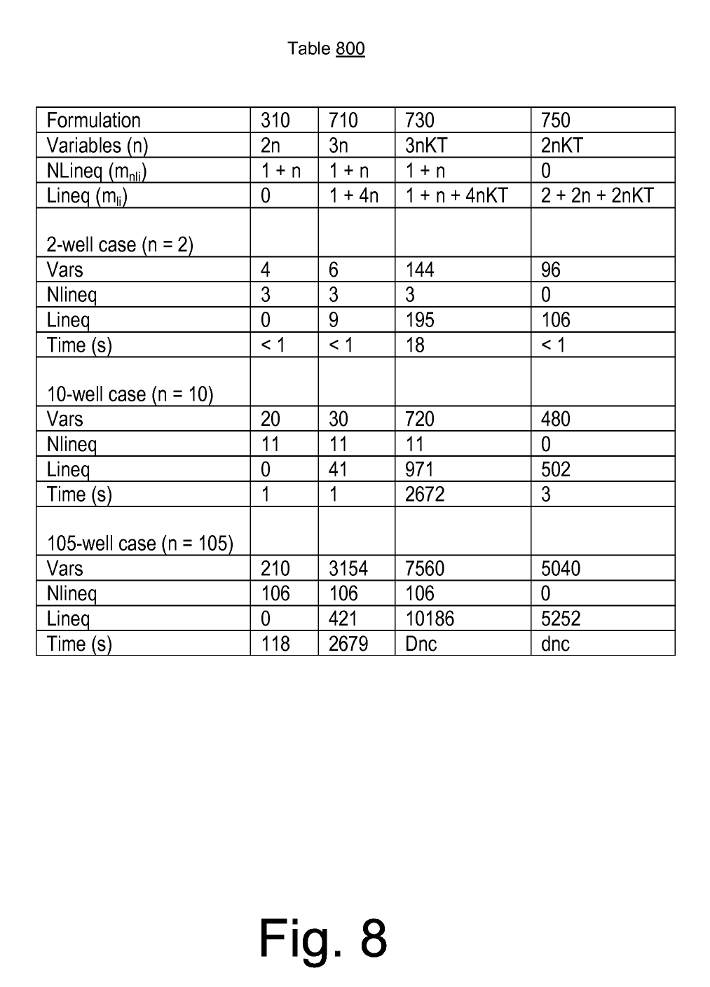

As an example, for the aforementioned set of equations (e.g., for the bilinear interpolation model), a 2-well scenario can include 4 variables, 3 nonlinear inequalities and be solved using a particular computing platform in less than 1 second (e.g., Intel i7 262 CPU 2.7 GHz 8 GB; see also the table 800 of FIG. 8). A 10-well scenario can include 20 variables, 11 nonlinear inequalities and be solved in about 1 second using the particular computing platform. A 105-well scenario can include 210 variables, 106 nonlinear inequalities and be solved in about 2 minutes using the particular computing platform. In the foregoing example, a near real-time solution is possible for over 100 wells.

As mentioned, a well deactivation procedure may be implemented. Such a procedure may expand a region or domain to include a zero choke setting while maintaining a lower bound on a gas-lift rate. In such an example, a programming problem may be solved neglecting a minimum desired choke constraint (see, e.g., foregoing equations).

As an example, if solution choke values meet the minimum choke setting requirement, an offline solution may be accepted and the iterative procedure continued (see, e.g., foregoing processes for the example GLO method). However, if the initial solution contains one or more choke values that are below the permissible minimum setting, appropriate action may be taken. For example, an initial solution may be viewed as being akin to solving a relaxed programming problem when integer variables (e.g., representing the well states) are in contention. In such an example, those which comply with the minimum desired choke setting may be active by default and those which do not can either be set to the minimum choke value (e.g., c=cₘᵢₙ) or deactivated (e.g., c=0). As an example, alternatively, a more rigorous branch and bound procedure may be implemented. For example, such an alternative approach may consider various possibilities for a set of wells, which mathematically would be more demanding than a fast shut-down approach (e.g., an approach that inherently includes a bias).

As an example, a well shut-down procedure may be implemented, for example, when well level constraints are to be met. As an example, a procedure can be adopted that will shut-down wells that operate below a specified minimum desired choke setting. As an example, wells that are switched off in a network simulator, due to sub-network or branch closures, can also be deactivated for stability reasons (e.g., in an effort to avoid oscillations that could hamper convergence with wells going on and off in consecutive iterations).

As an example, wells that operate below a minimum choke value can be deactivated with a zero choke setting. In addition, a well status can be set to off and a lift gas set to zero, with lₘᵢₙ=0. In such an example, a programming problem may then be re-solved with the lift-gas re-distributed amongst active wells. Such a procedure may repeat until the programming problem solution is acceptable over the wells of interest. As an example, an objective function may be cast as an economic function (e.g., considering monetary or other values).

As an example, a method can include a bilinear interpolation model for production profile interpolation. In such an example, the model may be implemented in an offline process. As an example, such an offline process may provide results for use in an online process. As an example, an interpolation model may be formulated to be part of a programming problem (e.g., a nonlinear programming problem, etc.). As an example, with respect to one or more control variables, a deactivation process may be implemented where actual physical entities are subject to deactivation in a network. For example, in a network of wells, a deactivation process may call for choking one or more wells to effectively deactivate those wells from the network.

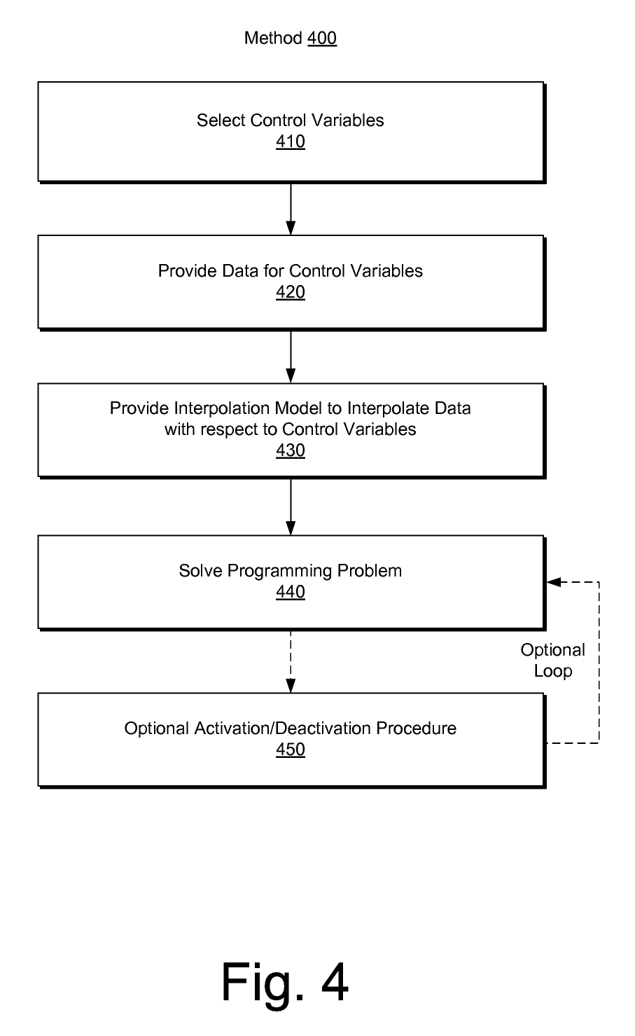

FIG. 4 shows an example of a method 400 that includes a selection block 410 for selecting control variables, a provision block 420 for providing data for the control variables, a provision block 430 for providing an interpolation model for interpolating data with respect to control variables, a solution block 440 for solving a programming problem and an optional activation/deactivation procedure block 450 that may provide, at least in part, for optimizing a solution (e.g., optionally via looping to the block 440 in an iterative manner). In such an example, a programming problem may be, for example, a nonlinear programming problem, a mixed-integer nonlinear programming problem or a mixed-integer programming problem. As an example, an interpolation model may be or include an integer-based interpolation model (e.g., a model that may represent various states along a continuum using integers).

As an example, a method may include selecting two control variables for a fluid production network; providing data acquired from the production network, the data associated with values for the two control variables; providing an interpolation model for interpolating the data over a domain defined by operational bounds for each of the two control variables; and solving a programming problem based at least in part on the interpolation model to provide values for at least one of the two control variables. As an example, such a method may also include deactivating at least a portion of the fluid production network (e.g., as part of an optimization procedure). As an example, a model may account for states, for example, consider a model that accounts for activation and deactivation states (e.g., for equipment in a fluid production network).

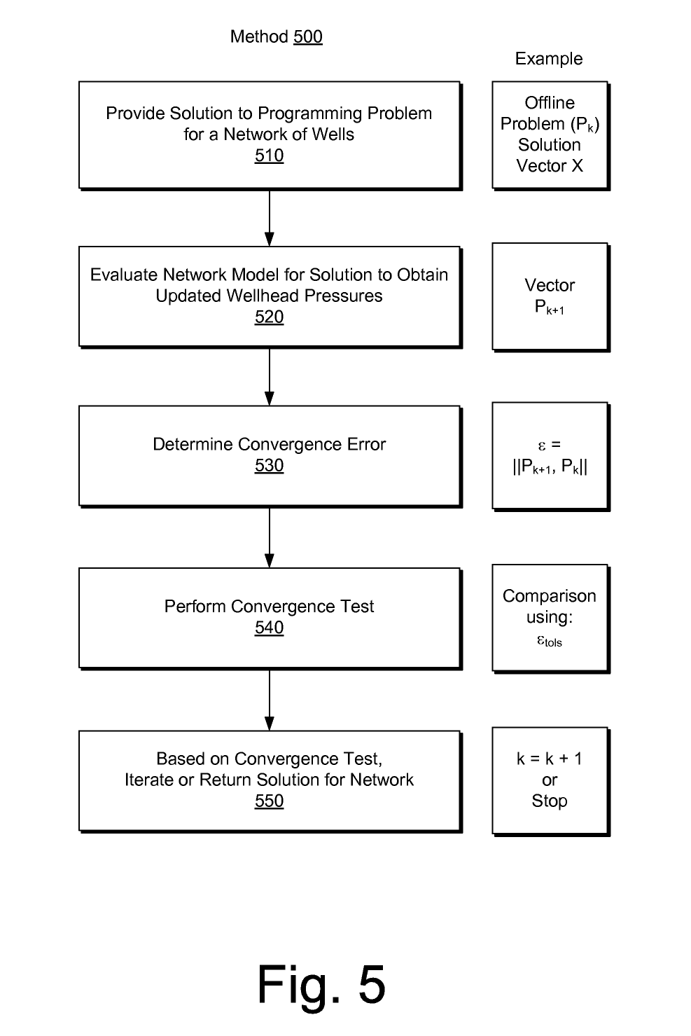

FIG. 5 shows an example of a method 500 that includes a provision block 510 for providing a solution to a programming problem (e.g., for WHP vector Pₖ, solution vector X), an evaluation block 520 for evaluating a network model for the solution to obtain updated wellhead pressures (e.g., WHP vector Pₖ₊₁), a determination block 530 for determining convergence error (e.g., based at least in part on Pₖ₊₁ and Pₖ), a performance block 540 for performing a convergence test(s) based on current and updated wellhead pressures (e.g., comparing calculated convergence error to one or more criteria) and an iterate or return block 550 for iterating or returning a solution for the network of wells based at least in part on convergence error (e.g., iterating k to k+1). As an example, such a method may account for states, for example, consider a method that accounts for activation and deactivation states (e.g., for equipment in a fluid production network).

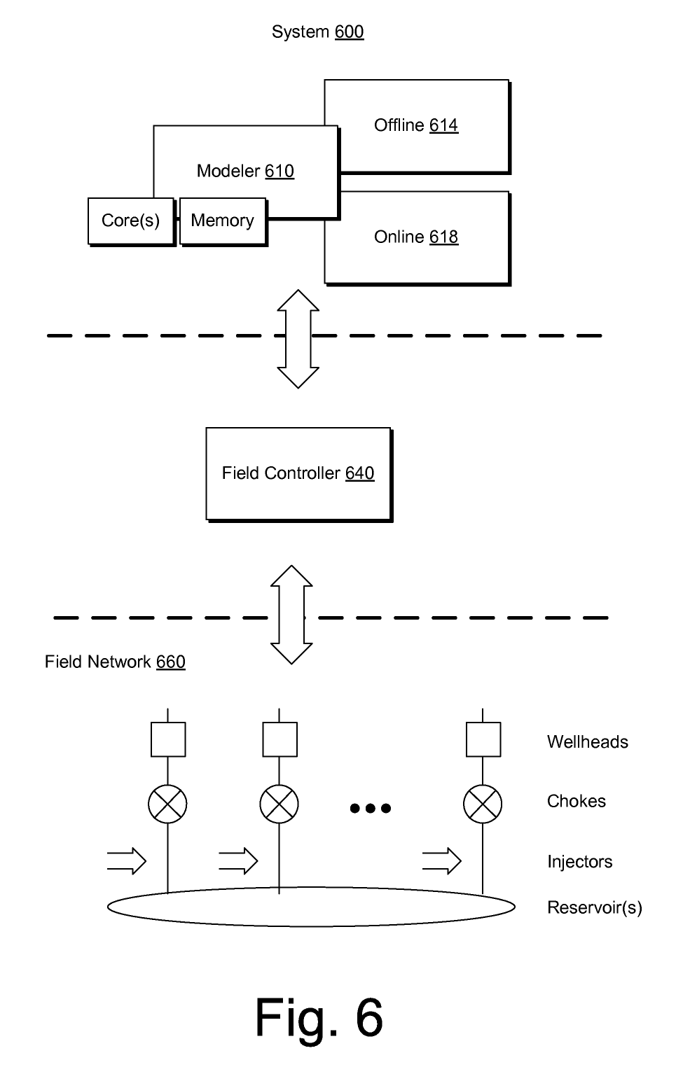

FIG. 6 shows an example of a system 600 that includes modeler 610 (e.g., including one or more cores and memory), instructions for offline modeling 614 and instructions for online modeling 618; a field controller 640; and a field network 660 that may include wellheads, chokes, and injectors, for example, to operate to produce material from one or more reservoirs. In the example of FIG. 6, data may flow from the field network 660 to the field controller 640 and to the modeler 610 or vice versa. As an example, one or more computer-readable storage media may include computer-executable instructions to instruct a computing system to perform a method (e.g., modeling, data acquisition, data access, control, reporting, etc.).

As an example, a method can include selecting two control variables for a fluid production network; providing data acquired from the production network, the data associated with values for the two control variables; providing an interpolation model for interpolating the data over a domain defined by operational bounds for each of the two control variables; and solving a programming problem based at least in part on the interpolation model to provide values for at least one of the two control variables. In such an example, a programming problem may be, for example, a nonlinear programming problem, a mixed-integer nonlinear programming problem or a mixed-integer programming problem. As an example, an interpolation model may be or include an integer-based interpolation model (e.g., a model that may represent various states along a continuum using integers).

As an example, such a method may include deactivating at least a portion of the fluid production network. As an example, a fluid production network can include wells where deactivating includes setting one of the two control variables for at least one of wells to a deactivation value. As an example, a method can include optimizing fluid production in the fluid production network at least in part by the deactivating.

As an example, a bilinear interpolation scheme may be effective for optimizing a high dimensional network model (e.g., of the order of a hundred variables or more) that includes wells where each well may include a gas-lift control and a choke control that define two control variables. However, as an example, such a scheme may not include equations that provide for consideration of well activation state (e.g., via setting control variable values for choke control). For example, such an approach may not yield sufficient convexity to allow for discrete choke optimization using a mixed-integer nonlinear programming problem approach.

As an example, a deactivation procedure may be applied. For example, a programming problem formulation for a bilinear interpolation scheme may include effectively neglecting a minimum choke constraint (e.g., the constraint that c≧cₘᵢₙ).

As an example, where a solution for choke values meets a minimum choke setting (e.g., constraint), an offline solution may be accepted and an iterative procedure may continue; however, where an initial solution includes one or more choke values that may be below a permissible minimum setting, corrective action may be taken. In such an example, the initial solution may be viewed akin to solving a relaxed programming problem where integer variables (e.g., representing well activation/deactivation states) are in contention. As an example, those which comply with a minimum desired choke setting may be active by default and those which do not may, for example, be set to the minimum choke value (e.g., by setting c=cₘᵢₙ) or deactivated (e.g., by setting c=0 or c˜0). As an example, mathematically, setting a variable to a relatively small value may achieve a result akin to setting that variable to a value equal to 0 (e.g., depending on precision of a computing device, etc.).

As an example, a deactivation procedure may include well shut-downs, for example, where the deactivation procedure shuts down wells that operate below a minimum desired choke setting (e.g., an off position, deceleration setting, etc.). As an example, wells that are switched off in a network simulator (e.g., due to sub-network or branch closures) may be deactivated for purposes of solution stability (e.g., to avoid oscillations in subsequent iterations).

Where a deactivation procedure is employed, as an example, a programming problem formulation may be re-solved, for example, with lift-gas re-distributed (e.g., amongst active wells). In such an example, iterations may occur, for example, until a solution to the programming problem formulation is deemed acceptable (e.g., according to one or more criteria). Various trial examples are described further below that consider activation and deactivation states (e.g., by setting values for at least one control variable).

As an example, an interpolation model can include a surface defined by the two control variables. In such an example, the two control variables may be an acceleration control variable and a deceleration control variable. While acceleration and deceleration are mentioned, which may be, for example, a gas-lift and a choke, control variable type may be selected to describe one or more other properties of interest. For example, dependent variables (e.g., F=f(x,y)) may describe gas-lift competing with horsepower for an ESP in well, gas-lift with a choke, or ESP with a choke, etc. As an example, an acceleration control variable may be a gas-lift control variable or a power control variable associated with a pump. As an example, a model may include a mixed acceleration control variable, for example, where two types of equipment may be normalized to as a control variable (e.g., represented along a particular axis for purposes of defining a surface). As an example, a deceleration control variable may be a choke control variable (e.g., that represents an adjustable setting of a choke).

As an example, a model may include at least one control variable that corresponds to a continuously adjustable control variable for a piece of equipment in a fluid production network. As an example, a model may include two control variables that are a gas-lift control variable and a choke control variable.

As an example, a method may include an offline method, for example, that is offline from a fluid production network. As an example, a method may include one or more online actions associated with values for at least one of two control variables for controlling production of fluid from the fluid production network. For example, an offline method may include a model of a fluid production network that may be solved in near-real time where at least a portion of the solution may be used to adjust one or more pieces of equipment in the fluid production network. As an example, a control loop may be implemented that includes a programming problem formulation, optionally including a formulation for activation and deactivation of production equipment (e.g., to activate or deactivate a well), optionally include a rigorous branch-and-bound procedure. As an example, a method may include solving a nonlinear programming problem (e.g., optionally a mixed-integer nonlinear problem), based at least in part on an interpolation model to provide values for the two control variables.

As an example, a system can include a field controller that includes data acquisition instructions; a field network that includes equipment controllable by the field controller; and a modeler that includes offline instructions and online instructions where the offline instructions include instructions for an interpolation model for modeling data acquired by the field controller for at least two control variables for equipment controllable by the field controller. In such an example, the system may include one or more processors and memory to store instructions, the instructions being executable by at least one of the one or more processors. As an example, a field network may include chokes and gas-lift equipment.

As an example, one or more computer-readable media (e.g., non-transitory) may include computer-executable instructions to instruct a computer to: solve a programming problem based in part on an interpolation model for data of a fluid production network with respect to control variables of the fluid production network to provide values for at least one of the control variables of the fluid production network. In such an example, the control variables may include an acceleration control variable and a deceleration control variable. As an example, the acceleration control variable may be a gas-lift control variable and the deceleration control variable may be a choke control variable.

As an example, a method can include selecting two control variables for a physical network; providing data acquired from the physical network, the data associated with values for the two control variables; providing an interpolation model for interpolating the data over a domain defined by operational bounds for each of the two control variables; and solving a programming problem based at least in part on the interpolation model to provide values for at least one of the two control variables. In such an example, the two control variables can include an acceleration control variable and a deceleration control variable. For example, an acceleration control variable may be a gas-lift control variable, a power control variable associated with a pump (e.g., an electric submersible pump), etc. As an example, a deceleration control variable may be a choke control variable.

As an example, a control variable may correspond to a continuously adjustable control variable for a piece of equipment or to a discretely adjustable control variable for a piece of equipment (e.g., consider an integer programming problem such as a mixed-integer nonlinear programming problem, etc.).

As an example, a gas-lift control variable and a choke control variable may be provided for a physical network such as a reservoir production network.

As an example, a method can include deactivating one or more elements in a physical network and representing the one or more deactivated elements being deactivated in an interpolation model.

As an example, a method can include a programming problem with a process that implements a deactivation procedure. As an example, such a method may include implementing a mixed-integer nonlinear programming process (MINLP), for example, to provide a solution to a problem.

As an example, a method may be an offline method, offline from a physical network. As an example, a method may include one or more online actions associated with values for at least one of control variables (e.g., as provided by a solution to a programming problem). As an example, a method can include solving a programming problem based at least in part on an interpolation model to provide values for two control variables (e.g., for each well in the problem).

As an example, a system can include a field controller that includes data acquisition instructions; a field network that includes equipment controllable by the field controller; and a modeler that includes offline instructions and online instructions where the offline instructions include instructions for an interpolation model for modeling data acquired by the field controller for at least two control variables for equipment controllable by the field controller. Such a system may include one or more processors and memory to store instructions, the instructions executable by at least one of the one or more processors. Such a system may include chokes and gas-lift equipment.

As an example, one or more computer-readable media can include computer-executable instructions to instruct a computer to: solve a programming problem based in part on an interpolation model for data of a physical network with respect to control variables of the physical network to provide values for at least one of the control variables of the physical network. Such an example may include control variables such as an acceleration control variable and a deceleration control variable. For example, an acceleration control variable may be a gas-lift control variable and a deceleration control variable may be a choke control variable.

As an example, a programming problem may be a nonlinear programming problem, mixed-integer nonlinear programming problem or a mixed-integer programming problem.

As an example, the PIPESIM™ framework (Schlumberger, Houston Tex.) may be implemented to model a physical network that includes wells (see, e.g., the examples of equipment of FIGS. 1 and 2). The PIPESIM™ framework can provide for comprehensive well performance analyses for gas-lift systems. As an example, a gas-lift system may be sized and analyzed, for example, for performance to increase production. As an example, the PIPESIM™ framework may provide for well performance analyses for a system that includes one or more electric submersible pumps (ESPs). For example, fluid, well, and reservoir information may be input for prediction of inflow and outflow performance of an ESP well or wells. As an example, one or more methods described herein may be implemented within a framework such as the PIPESIM™ framework.

As an example, one or more computer-readable media may include computer-executable instructions to instruct a computing system to output information for controlling a process. For example, such instructions may provide for output to sensing process, an injection process, drilling process, an extraction process, etc.

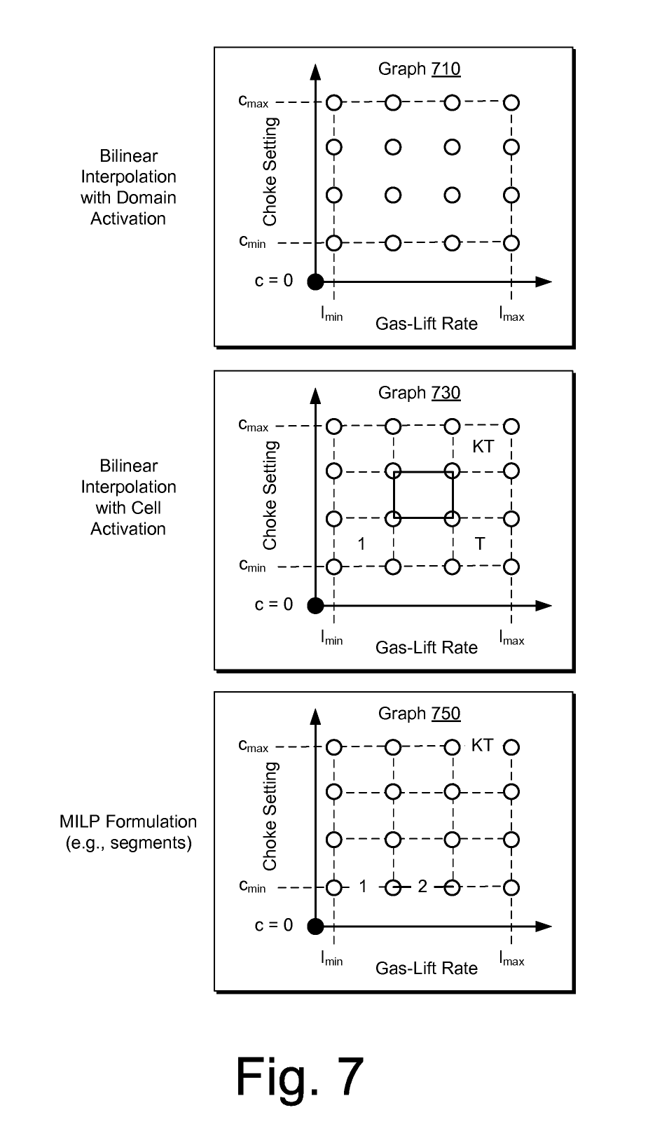

As mentioned, trials for various approaches were performed, for example, to provide a comparison of such approaches. Again, FIG. 3 shows a graph 310 that, as described above, corresponded to a bilinear interpolation approach. FIG. 7 shows a graph 710 associated with a bilinear interpolation with domain activation approach, a graph 730 associated with a bilinear interpolation with cell activation approach, and a graph 750 associated with MILP formulation (e.g., using segments, etc.).

FIG. 8 shows a table 800 that includes results from various trials for the aforementioned approaches as associated with the graphs 310, 710, 730 and 750. The table 800 includes results for trials that included two wells, 10 wells and 105 wells. The bilinear interpolation approach (e.g., as associated with the graph 310) demonstrated an ability to provide a solution to over 100 wells in about 2 minutes. Such an approach may be implemented in near-real time; whereas, the other approaches either take over an order of magnitude longer or, for example, do not converge to a solution within a time limit (e.g., one hour or about 3600 seconds).

In the table 800, n is the number of wells and the product term KT indicates the number of model cells (see, e.g., the graph 730) or segments (see, e.g., the graph 750) for a given well. For the trials, the number of lift rate values (Lₙ) was 9 and number of choke values (Cₙ) was 4 in the data. NLineq and Lineq refer to the number of nonlinear and linear inequality constraints, respectively. For the trials, model dimensions and runtimes are presented in the table 800 for 2, 10 and 105 well scenarios.

As to the bilinear interpolation with domain activation approach, consider the following equations:

$$max {\sum }_{i = 1}^{n} {q}_{i} = {\sum }_{i = 1}^{n} B ( {1}_{i} , {c}_{i} \vert {D}_{i} , {p}_{i} )$$

$$s . t . , {\sum }_{i = 1}^{n} {1}_{i} \leq {C}_{g}$$

$${1}_{i}^{min} \leq {1}_{i} \leq {1}_{i}^{max}$$

$${c}_{i}^{min} \leq {c}_{i} \leq {c}_{i}^{max}$$

$${y}_{i} {1}_{i}^{min} \leq {1}_{i} \leq {y}_{i} {1}_{i}^{max}$$

$${y}_{i} {c}_{i}^{min} \leq {c}_{i} \leq {y}_{i} {c}_{i}^{max}$$

$${y}_{i} ∈ \{ 0 , 1 \}$$

$${q}_{i} \leq {q}_{con , i}^{well} \\ {\sum }_{i = 1}^{n} {q}_{i} \leq {q}_{con}^{field} \\ ∀ i ∈ I$$

In the foregoing equations, lᵢ and cᵢ are the gas-lift and choke setting variables and yᵢ is a binary variable that dictates well activation. If yᵢ=1, then equations define the effective lower and upper bounds of the model. However, if yᵢ=0, then the same equations enforce the requirement that both lᵢ and cᵢ are zero. Thus, this mechanism allows well activation to be included in a scenario.

In the bilinear interpolation with domain activation, the resulting problem may be a mixed-integer nonlinear program (MINLP) that introduces its own complication, specifically, with respect to a convexity requirement demanded by the solver. As an example, an alternative approach may include placing yᵢ as a multiplier in the maximization equation, however, this may involve use of a heuristic optimization procedure. This particular approach has 3n variables, where n is the number of wells, representing the gas-lift rate (l), the choke setting (c) and activation state (y) in each well (see, e.g., the graph 710 of FIG. 7).

As to the bilinear interpolation with cell activation approach, consider the following equations where cells in the model are considered individually:

$$max {\sum }_{i = 1}^{n} {q}_{i}$$

$$s . t . , {\sum }_{i = 1}^{n} {1}_{i} \leq {C}_{g}$$

$${1}_{i} = {\sum }_{t = 1}^{T} {\sum }_{k = 1}^{K} {1}_{i}^{t , k}$$

$${c}_{i} = {\sum }_{t = 1}^{T} {\sum }_{k = 1}^{K} {c}_{i}^{t , k}$$

$${q}_{i} = {\sum }_{t = 1}^{T} {\sum }_{k = 1}^{K} B ( {1}_{i}^{t , k} , {c}_{i}^{t , k} \vert {D}_{i} , {p}_{i} )$$

$${y}_{i}^{t , k} {1}_{i , min}^{t , k} \leq {1}_{i} \leq {y}_{i}^{t , k} {1}_{i , max}^{t , k}$$

$${y}_{i}^{t , k} {c}_{i , min}^{t , k} \leq {c}_{i} \leq {y}_{i}^{t , k} {c}_{i , max}^{t , k}$$

$${\sum }_{t = 1}^{T} {\sum }_{k = 1}^{K} {y}_{i}^{t , k} \leq 1$$

$${y}_{i}^{t , k} ∈ \{ 0 , 1 \}$$

$${q}_{i} \leq {q}_{con , i}^{well}$$

$${\sum }_{i = 1}^{n} {q}_{i} \leq {q}_{con}^{field}$$

$$∀ i ∈ I , \\ k ∈ K , \\ t ∈ T$$

In the foregoing equations, where lᵢ^{k,t} and cᵢ^{k,t} are the components of cell (t, k). Equations are included to define the lower and upper bounds of cell (t, k) if yᵢ^{k,t} is unity (e.g., equal to 1). As an example, where yᵢ^{k,t} is equal to zero, these equations enforce that lᵢ^{k,t} and cᵢ^{k,t} are both zero. As an example, an equation for a summation of y dictates that at most one cell in the well model can be active. As an example, where the summation is zero, a well is deactivated. The foregoing approach includes 3nKT variables, where n is the number of wells and the product KT indicates the number of cells in the well model (see, e.g., the graph 730 of FIG. 7).

As to the mixed-integer linear program (MILP) formulation, consider the following equations:

$$max {\sum }_{i = 1}^{n} {q}_{i}$$

$$s . t . , {\sum }_{i = 1}^{n} {1}_{i} \leq C$$

$${1}_{i} = {\sum }_{t = 1}^{T} {\sum }_{k = 1}^{K} {1}_{i}^{t , k}$$

$${q}_{i} = {\sum }_{t = 1}^{T} {\sum }_{k = 1}^{K} {m}_{i}^{t , k} {1}_{i}^{t , k} + {c}_{i}^{t , k} {y}_{i}^{t , k}$$

$${y}_{i}^{t , k} {1}_{i , min}^{t , k} \leq {1}_{i}^{t , k} \leq {y}_{i}^{t , k} {1}_{i , max}^{t , k}$$

$${\sum }_{t = 1}^{T} {\sum }_{k = 1}^{K} {y}_{i}^{t , k} \leq 1$$

$${y}_{i}^{t , k} ∈ \{ 0 , 1 \}$$

$${q}_{i} \leq {q}_{con , i}^{well}$$

$${\sum }_{i = 1}^{n} {q}_{i} \leq {q}_{con}^{field}$$

$$∀ i ∈ I , \\ k ∈ K , \\ t ∈ T$$

In the foregoing equations, as an example, the equation for the summation of y implies that the choke can be set to at most one non-zero position, with one active linear segment. Where the binary variable y is equal to zero, for some t and k, then lᵢ is equal to zero. If y for some k and t is unity, then l and the production value is established by a linear model in the equation for q. The foregoing approach has a model with 2nKT variables, corresponding to an imposition of 2+2n+2nKT linear constraints, where n is the number of wells and product KT indicates the number of linear segments in each well model, with T=Lₙ−1 and K=Cₙ where Lₙ and Cₙ define the number of lift rate and choke settings in the data model (see, e.g., the graph 750 of FIG. 7). In the foregoing equations, m is a gradient of a linear segment and c is an intercept of a linear segment.

Various trials were performed using a gathering system (e.g., a production network) that includes 182 wells, including 105 gas-lift wells and 77 natural producers. In the trials, each gas-lift well has a single downhole valve that can be tuned to meet target production limits. Constraints were imposed at the individual well level and over the entire field. Available lift gas was assumed to vary.

The following results serve to demonstrate utility of combined gas-lift and choke control based on various formulations. Notably, while each formulation provides results for lower dimensional cases (e.g., a 26-well model), they do not scale similarly. As an example, solver stability may be a concern as a network simulator may act to shut down a number of wells, for example, due to sub-network or branch closures that may arise from reverse flow.

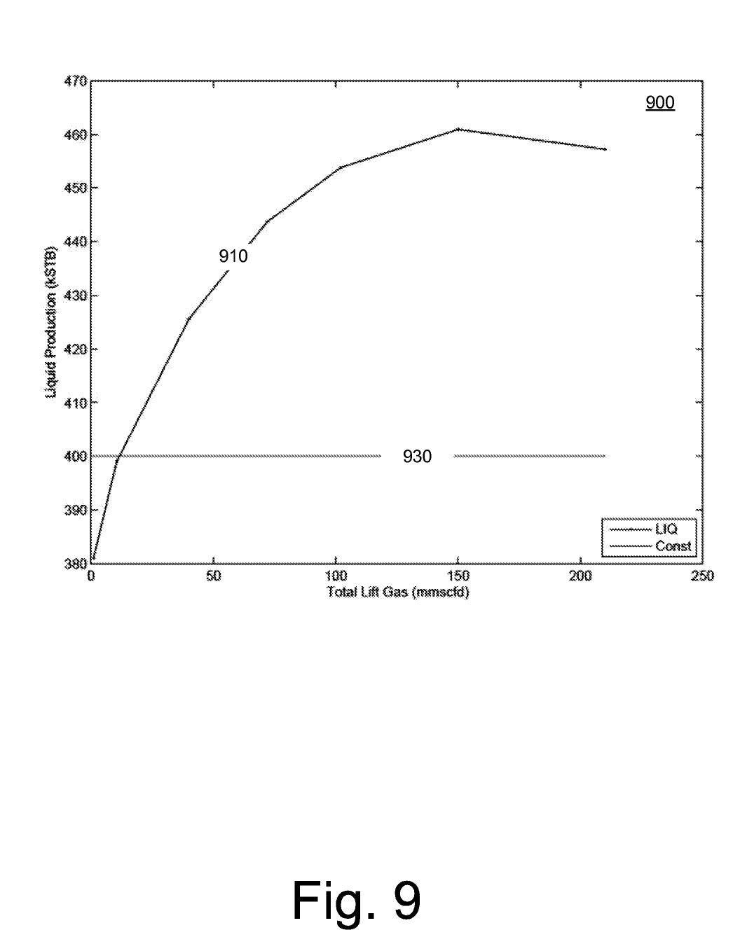

FIG. 9 shows a plot of production versus lift gas, for example, values at a sink with varying quantities of uniformly distributed lift-gas. The data 910 demonstrate that the production level increases with the introduction of lift-gas while the line 930 identifies a production limit.

Results from the bilinear interpolation model are presented in Table 1. In Table 1, Case 0 is the uniformly distributed solution with 40 mmscfd of available lift gas; Case 1 optimizes for lift rates and Case 2 includes chokes settings; and Cases 3 and 4 include field and well level constraints, respectively. Plots presented in various figures show solution pressure, flowrate, lift rate and choke setting profiles for Cases 1-4 of Table 1. The results show that the lift rates and chokes settings may be optimally adjusted to maximize the sink production rate while meeting field and well level limits that have been imposed.

TABLE 1

| | Field | Well | | Net | Lift Gas | |
|---|---|---|---|---|---|---|
| Case | Const | Const | Variables | Evals | Used | Sink Liq |
| 0 | 0 | 0 | 0 | 1 | 40 | 425K |
| 1 | 0 | 0 | L | 4 | 40 | 438K |
| 2 | 0 | 0 | L, C | 4 | 40 | 436K |
| 3 | 400K | 0 | L, C | 11 | 39.75 | 399K |
| 4 | 400K | 5K | L, C | 5 | 40 | 341K |

In the example cases of Table 1 (Cases 0, 1, 2, 3 and 4), the available lift gas quantity is 40 mmscfd, L is the vector of well lift rates and C is the vector of well choke settings; noting that Case 0 is the aforementioned uniformly distributed solution.

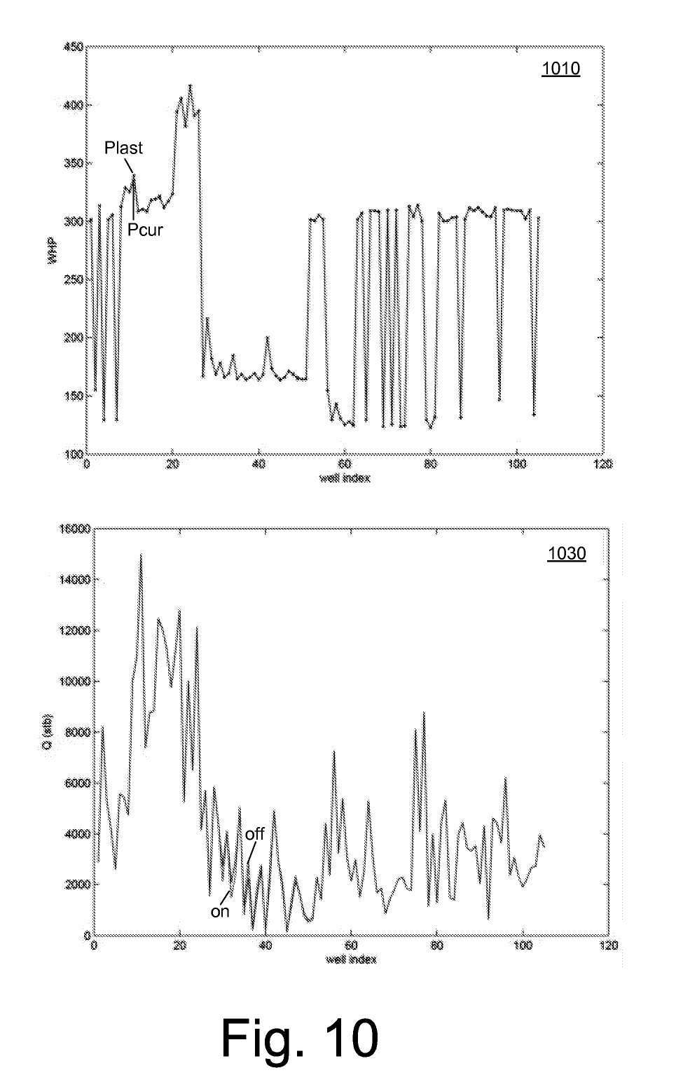

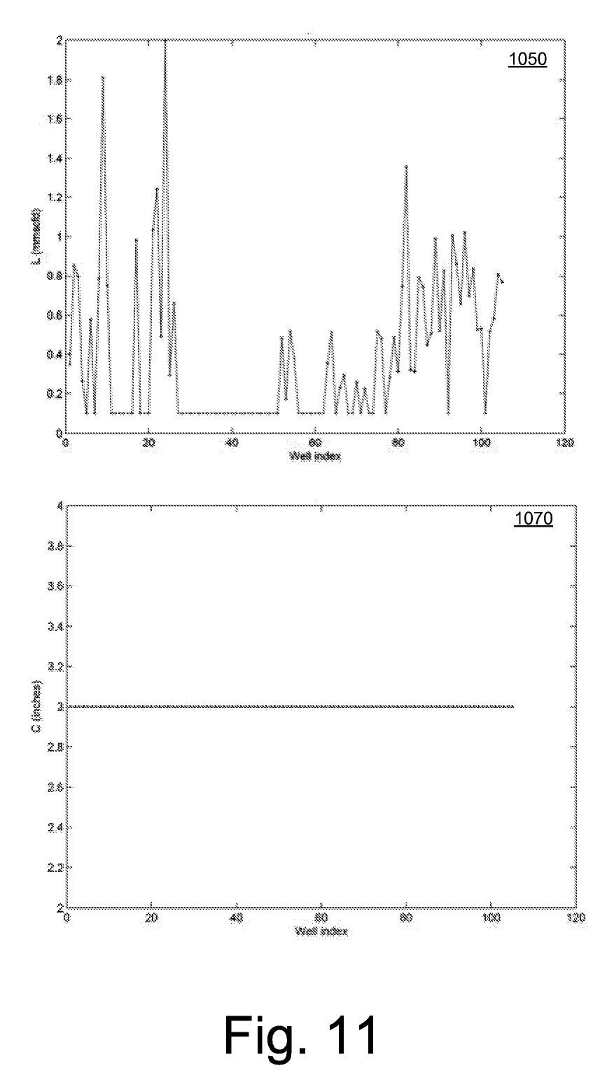

FIGS. 10 and 11 correspond to Case 1 and show a plot 1010 of a pressure solution profile (e.g., optimize L with no constraints), a plot 1030 of a solution flowrate profile (e.g., optimize L with no constraints with online and offline flowrate profiles), a plot 1050 of a solution gas-lift rate profile (e.g., optimize L with no constraints), and a plot 1070 of a solution choke setting profile (e.g., optimize L with no constraints).

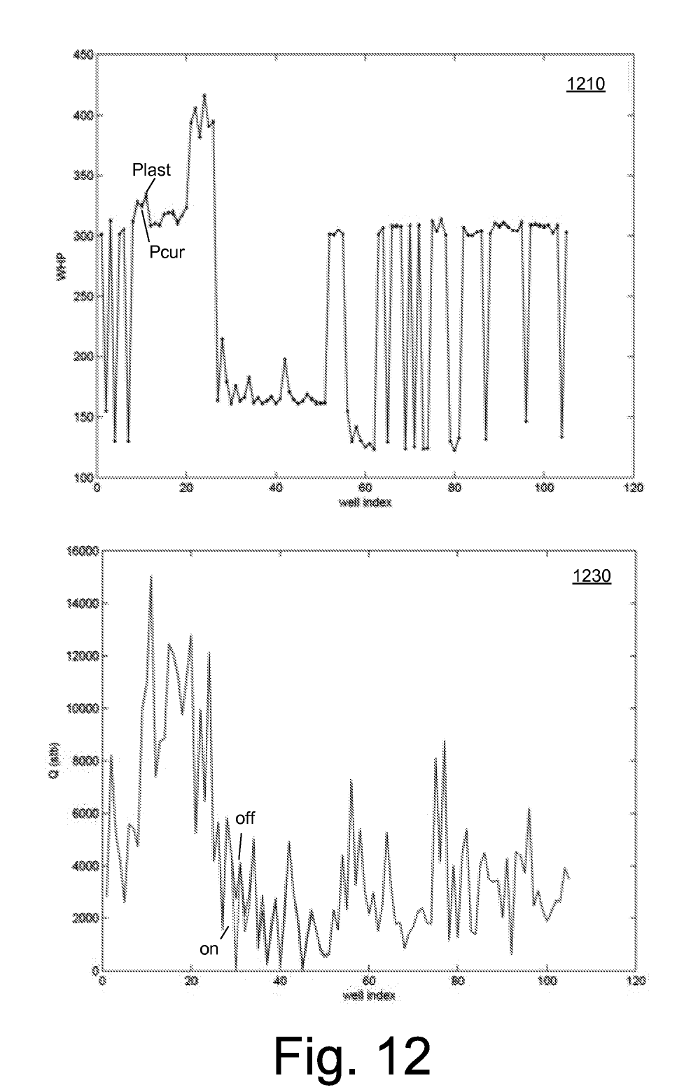

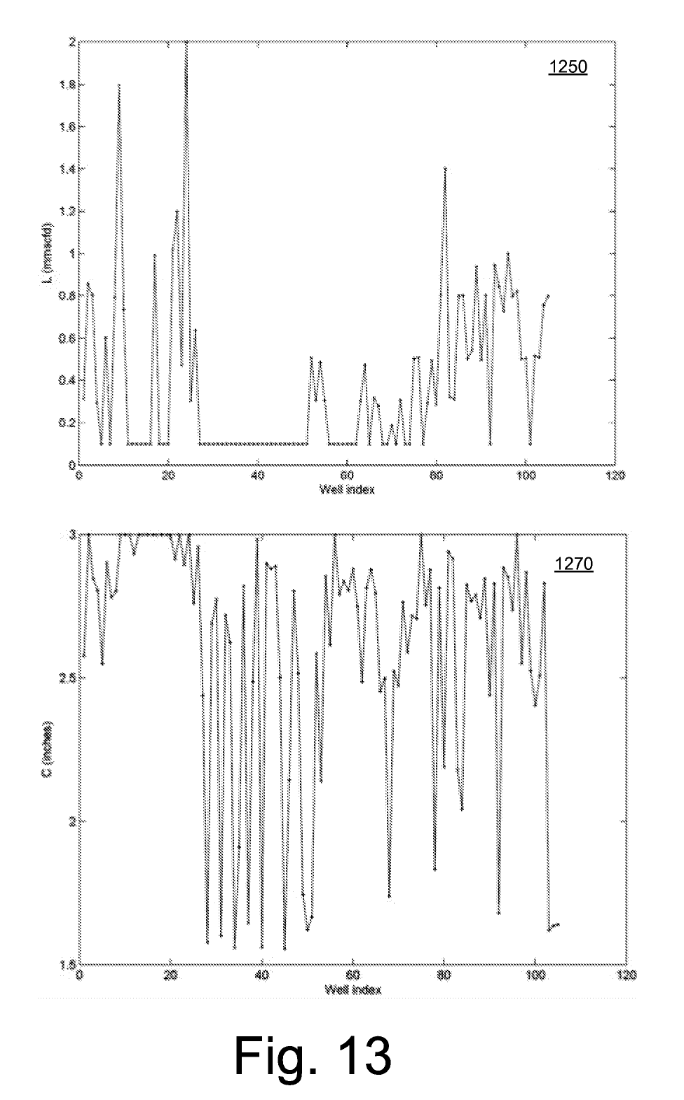

FIGS. 12 and 13 correspond to Case 2 and show a plot 1210 of a pressure solution profile (e.g., optimize L and C with no constraints), a plot 1230 of a solution flowrate profile (e.g., optimize L and C with no constraints with online and offline flowrate profiles), a plot 1250 of a solution gas-lift rate profile (e.g., optimize L and C with no constraints), and a plot 1270 of a solution choke setting profile (e.g., optimize L and C with no constraints).

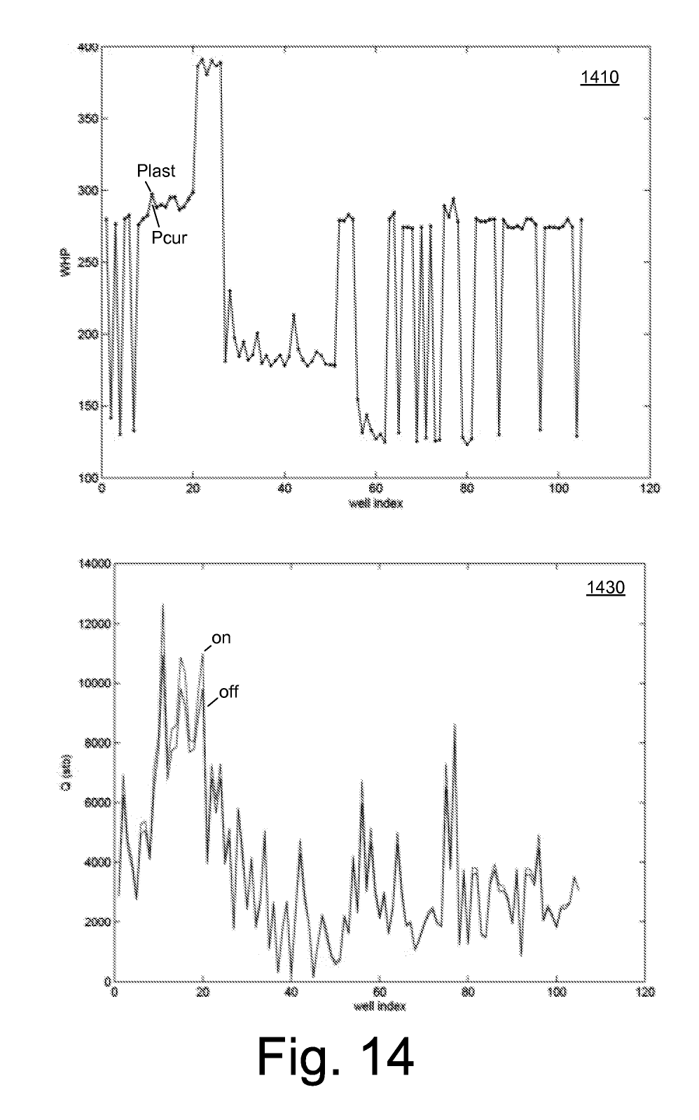

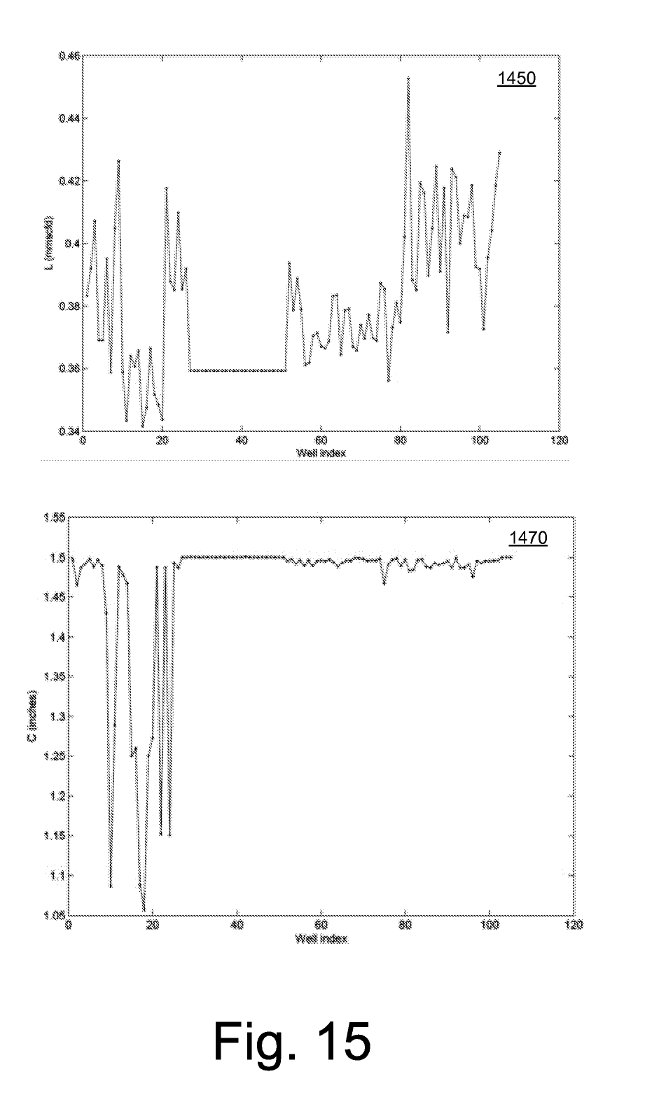

FIGS. 14 and 15 correspond to Case 3 and show a plot 1410 of a pressure solution profile (e.g., optimize L and C with a field constraint), a plot 1430 of a solution flowrate profile (e.g., optimize L and C with a field constraint with online and offline flowrate profiles), a plot 1450 of a solution gas-lift rate profile (e.g., optimize L and C with a field constraint), and a plot 1470 of a solution choke setting profile (e.g., optimize L and C with a field constraint).

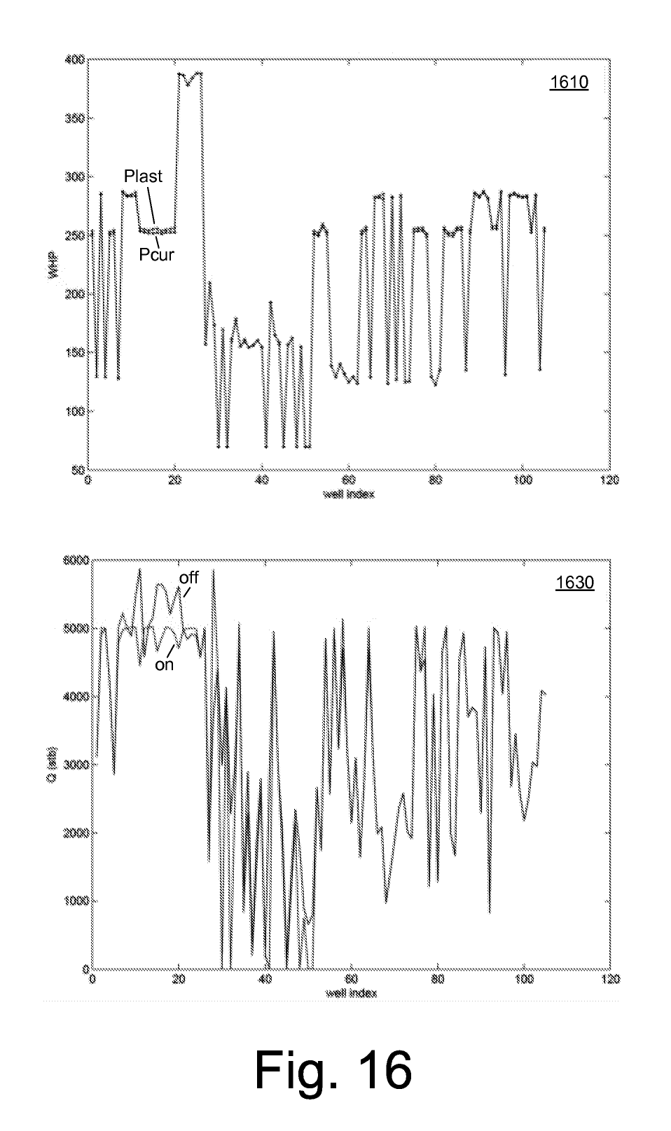

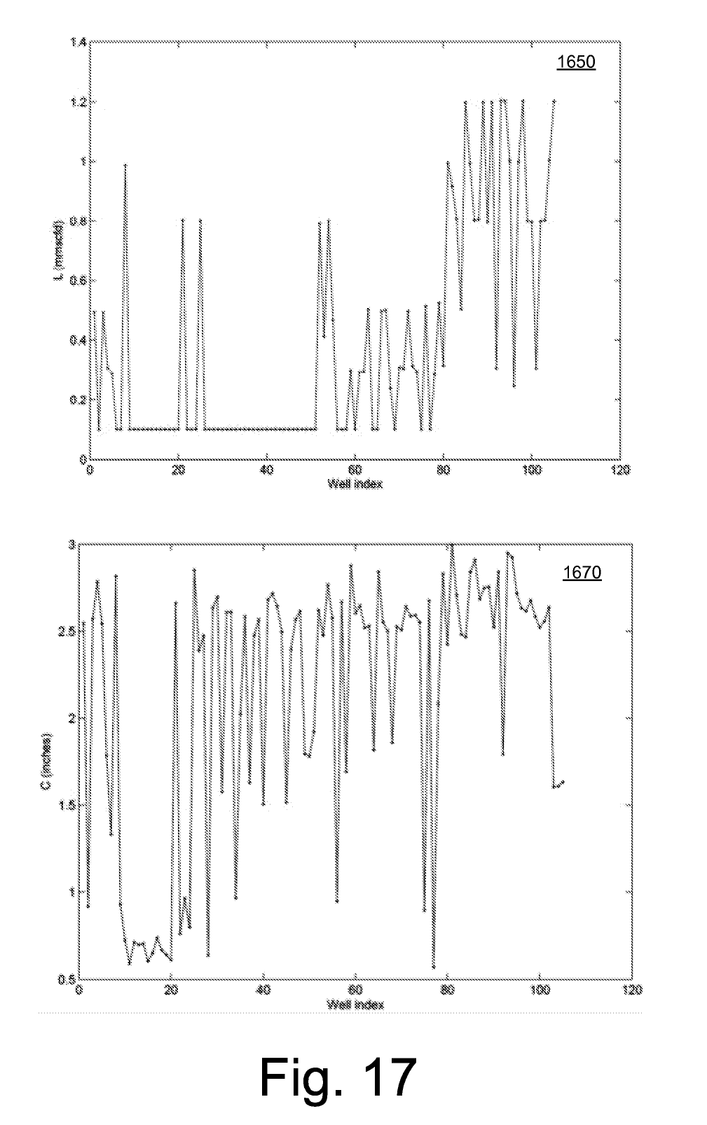

FIGS. 16 and 17 correspond to Case 4 and show a plot 1610 of a pressure solution profile (e.g., optimize L and C with field and well constraints), a plot 1630 of a solution flowrate profile (e.g., optimize L and C with field and well constraints with online and offline flowrate profiles), a plot 1650 of a solution gas-lift rate profile (e.g., optimize L and C with field and well constraints), and a plot 1670 of a solution choke setting profile (e.g., optimize L and C with field and well constraints).

Trials demonstrated that a bilinear interpolation scheme was effective for optimizing high dimensional network models with gas-lift and choke control in wells. Such a scheme does not consider well activation state (e.g., activation/deactivation states) implicitly, which may be useful to manage well-level constraints. To account for such states, a method may include a well deactivation procedure.

As an example, a solution domain may be expanded to include a zero choke setting (e.g., c=0 or c˜0) where a lower bound on gas-lift rate (lₘᵢₙ) is initially retained. In such an example, a programming problem may then be solved neglecting the minimum desired choke constraint (cₘᵢₙ). In such an example, where solution choke values meet the minimum choke setting requirement, the offline solution may be deemed acceptable and one or more iterations may proceed (see, e.g., Table 1). However, where the initial solution includes one or more choke values that are below the permissible minimum setting, action may be indicated. In such a manner, the initial solution may be viewed to be akin to solving the relaxed nonlinear programming problem (NLP) where integer variables (e.g., representing the well states) are in contention. In such an example, those values that comply with the minimum desired choke setting may be active by default and those that do not may either be set to the minimum choke value (cₘᵢₙ) or deactivated (c=0 or c˜0). As an example, a rigorous branch-and-bound procedure may be implemented (e.g., as an alternative).

A rigorous treatment may entail use of a branch-and-bound procedure to set the choke value of a well operating below a minimum setting. However, as various programming problems may be expected to resolve integrality requirements (i.e., well is either on at cₘᵢₙ or off), it may be more expedient and efficient to consider a well shut-down procedure. Such a procedure may be beneficial where well level constraints are to be met. Thus, as an example, a deactivation procedure may provide a means to shut down wells that operate below a minimum desired choke setting. Additionally, as an example, wells that are switched off in a network simulator (e.g., due to sub-network or branch closures) may be deactivated (e.g., for stability reasons). As an example, a stability issue may be seen as oscillations that hamper convergence, for example, as wells go on and off in consecutive iterations (see, e.g., cases A0 and A1 in Table 2).

As an example, in a deactivation procedure, wells that operate below a minimum choke value may be deactivated by setting a choke variable value for a respective well to zero (e.g., a zero choke setting). As an example, well status may be set to off and lift-gas may be set to zero (e.g., with lₘᵢₙ=0 or lₘᵢₙ˜0), accordingly. Such an approach may act to direct lift-gas to active wells (e.g., re-distribute available lift-gas to wells that may benefit from such lift). As an example, a programming problem may be re-solved with lift-gas re-distributed amongst active wells. Such a process may repeat, for example, until a programming problem solution is acceptable over the wells.

Several trials were performed for a number of cases with 100 mmscfd of available lift gas, with both well and field level constraints applied. As an example, an objective function may be generalized to an economic function as follows:

$$F ( L , C ) = {\sum }_{i = 1}^{n} [ {q}_{i} ( {p}_{o} ( 1 - {ω}_{i} ) + {p}_{g} {γ}_{i} ( 1 - ω ) - {c}_{w} ω ) - {c}_{g} {1}_{i} ]$$

where ωᵢ and γᵢ are the water-cut and gas-oil-ratio values for well i. In the foregoing function, pₒ and p_{g} represent the sale price of the produced oil and gas in units of $/STB and in units of $/mmscfd, respectively, while c_{w} and c_{g} represent the water disposal and lift gas utilization cost, respectively. In the foregoing function, lᵢ indicates the amount of lift gas assigned to well i (from n) with choke setting cᵢ and production qᵢ. In an example scenario, pₒ=1, p_{g}=0, c_{w}=0 and c_{g}=100, with ω=0 for liquid rate optimization. Such parameters may optionally be set at a user's discretion (e.g., for considering one or more scenarios).

Results from various trials are presented in Table 2 where Case A0 optimizes lift rates and chokes settings without the deactivation procedure; Case A1 is the same as Case A0, but achieves a solution more efficiently by including the well deactivation procedure; Case A2 includes a field level constraint, while case A3 additionally imposes well level constraints. Figures include plots that show solution pressure, flowrate and control variables for the various cases of Table 2. The trials demonstrate that a deactivation procedure can enable well constraints to be better managed, while also making a simulation process more stable (e.g., for the particular model implemented).

TABLE 2

| | Field | Well | | Net | Lift Gas | |
|---|---|---|---|---|---|---|
| Case | Const | Const | Variables | Evals | Used | Sink Liq |
| A0 | 0 | 0 | L, C | 15 | 100 | 448K |
| A1 | 0 | 0 | L, C | 3 | 99.9 | 448K |
| A2 | 400K | 0 | L, C | 6 | 96.7 | 400K |
| A3 | 400K | 4K | L, C | 11 | 99.8 | 250K |

In the example cases of Table 2 (Cases 0, 1, 2 and 3), the available lift gas quantity is 100 mmscfd, L is the vector of well lift rates and C is the vector of well choke settings. In Table 2, the Case A1 result is achieved more readily when well deactivation is permitted, compared to Case A0 where the deactivation procedure is not used; noting cₘᵢₙ=0.6 in and that the objective function is scaled (e.g., by a factor 1e-5) during optimization.

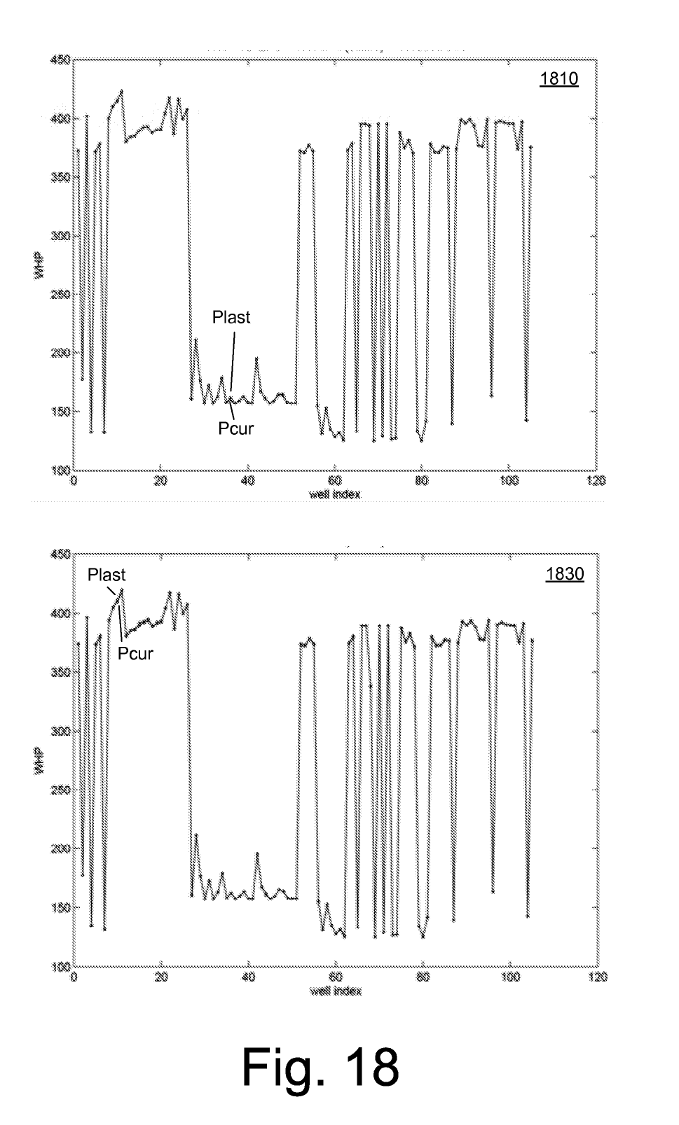

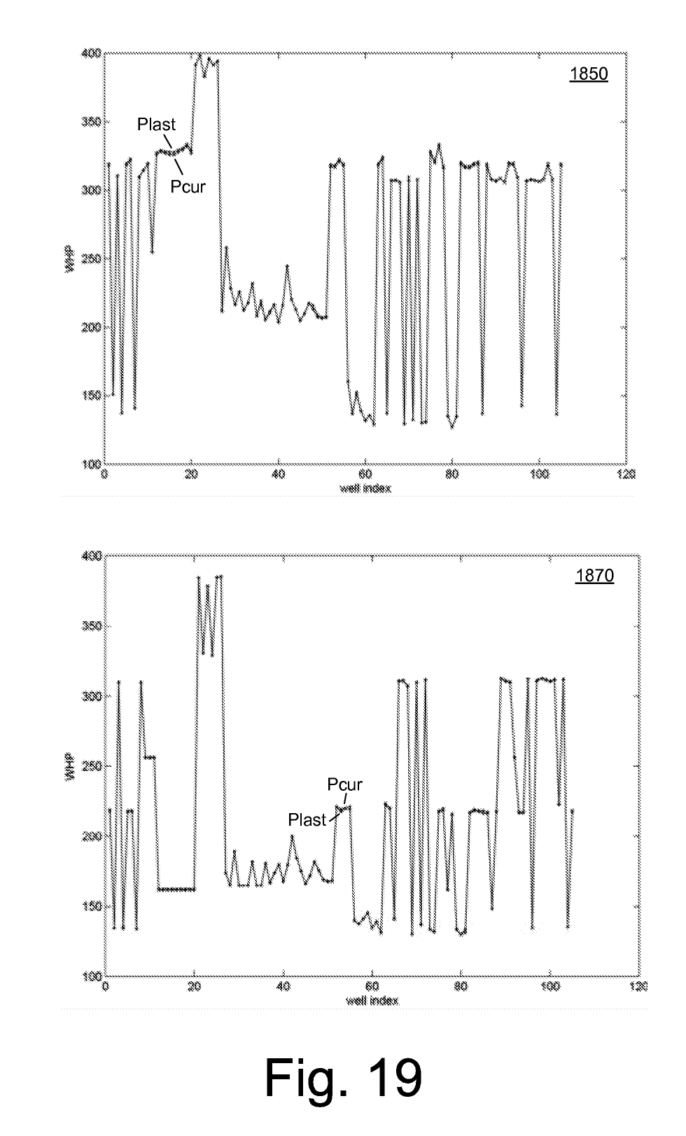

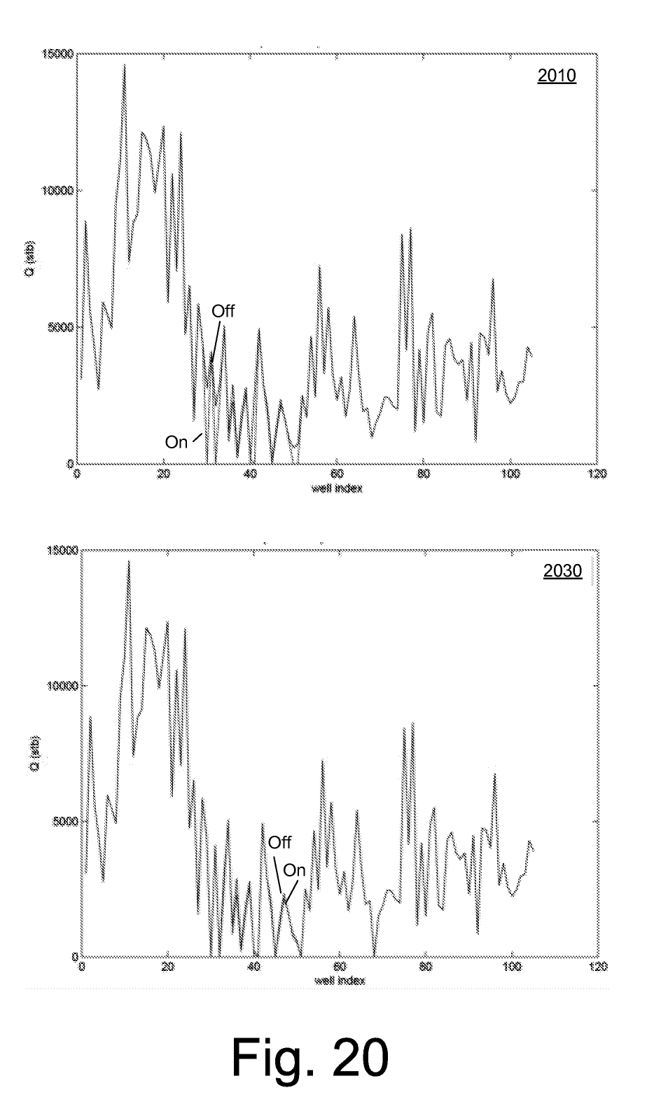

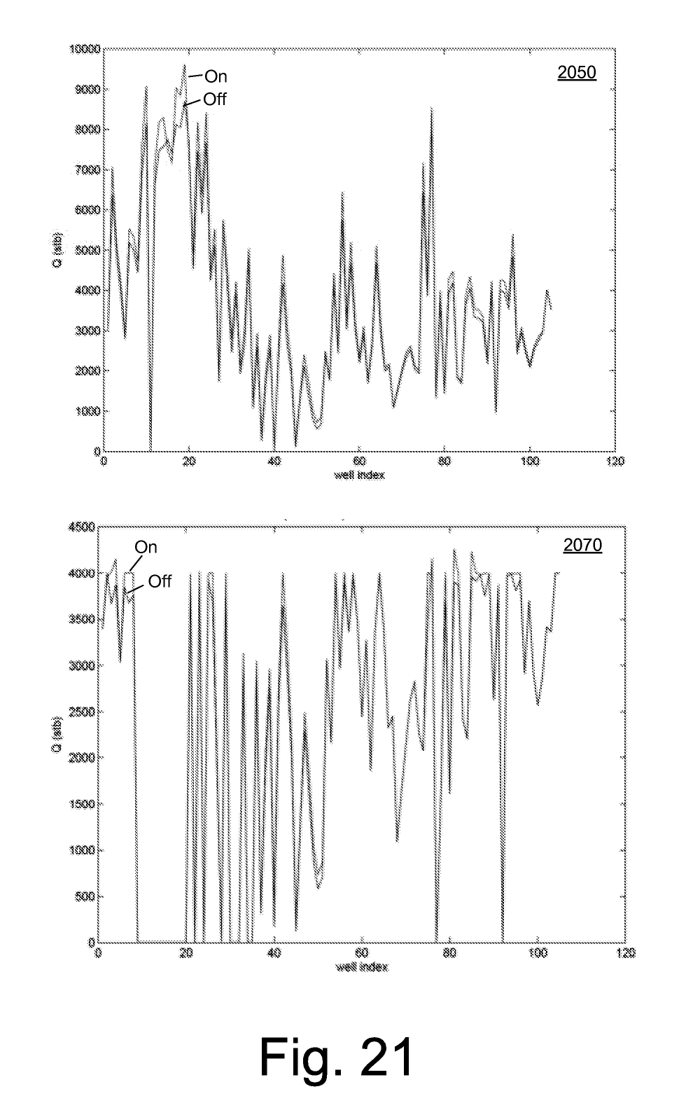

FIGS. 18 and 19 show solution pressure profiles for Cases A0 to A3 as plots 1810, 1830, 1850 and 1870, respectively. FIGS. 20 and 21 show solution flowrate profiles for Cases A0 to A3 as plots 2010, 2030, 2050 and 2070, respectively.

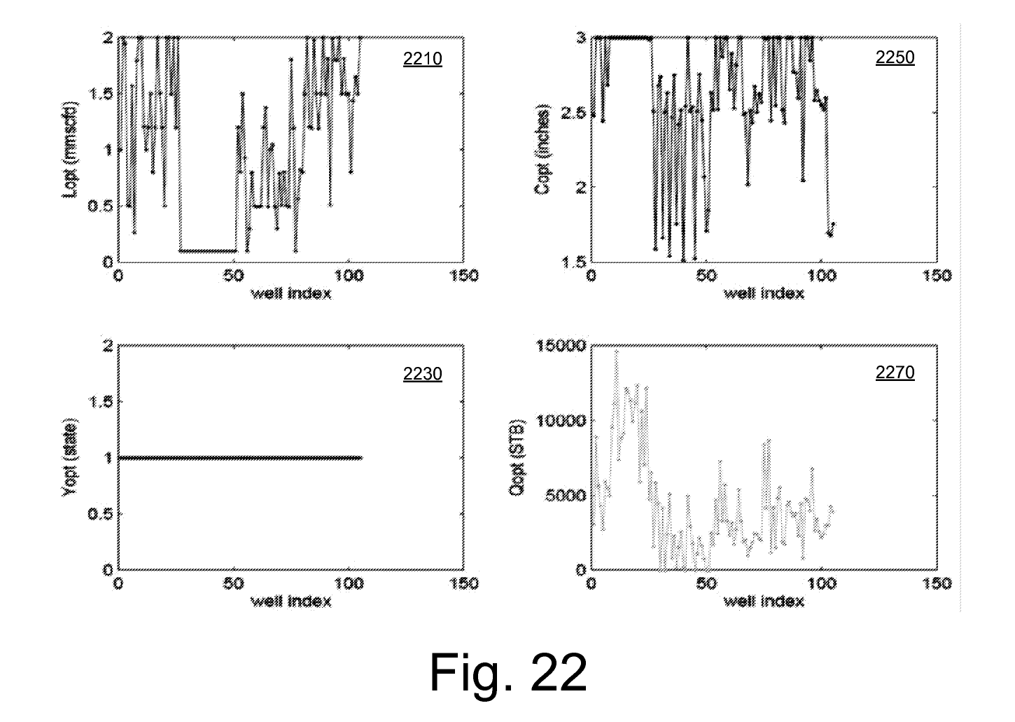

FIG. 22 shows example solution plots for Case A0 (e.g., optimize L and C with no constraints or deactivation): plot 2210 as gas-lift rates (Lₒₚₜ), plot 2230 as choke settings (Cₒₚₜ), plot 2250 as activation states (Yₒₚₜ), and plot 2270 as flowrates (Qₒₚₜ).

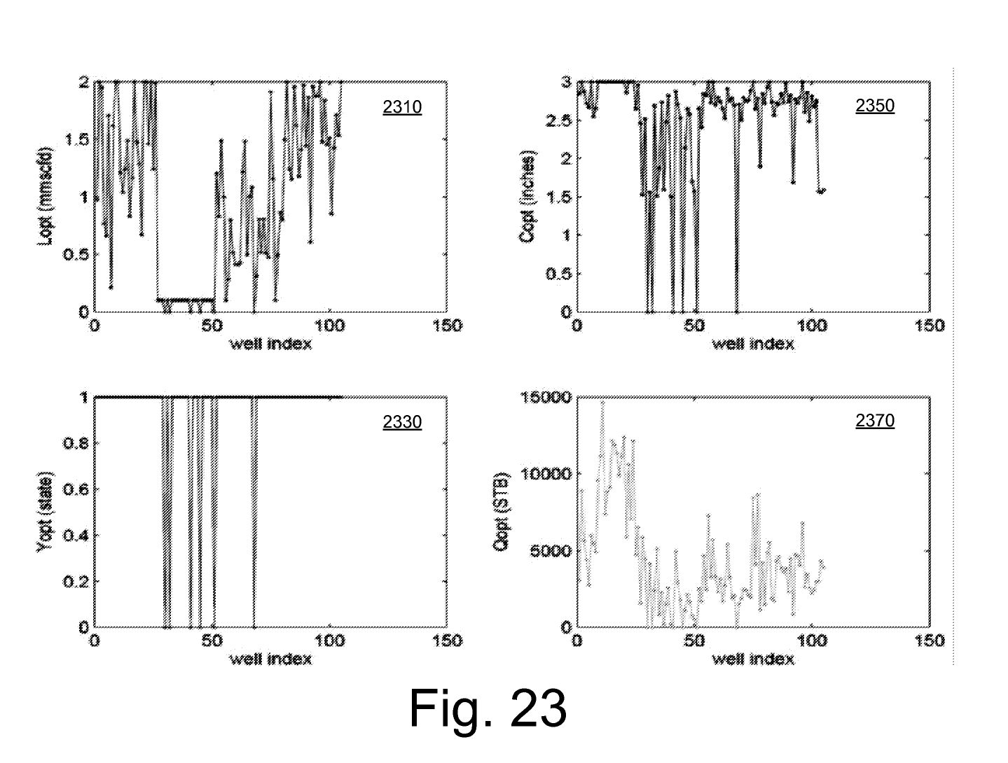

FIG. 23 shows example solution plots for Case A1 (e.g., optimize L and C with no constraints): plot 2310 as gas-lift rates (Lₒₚₜ), plot 2330 as choke settings (Cₒₚₜ), plot 2350 as activation states (Yₒₚₜ), and plot 2370 as flowrates (Qₒₚₜ).

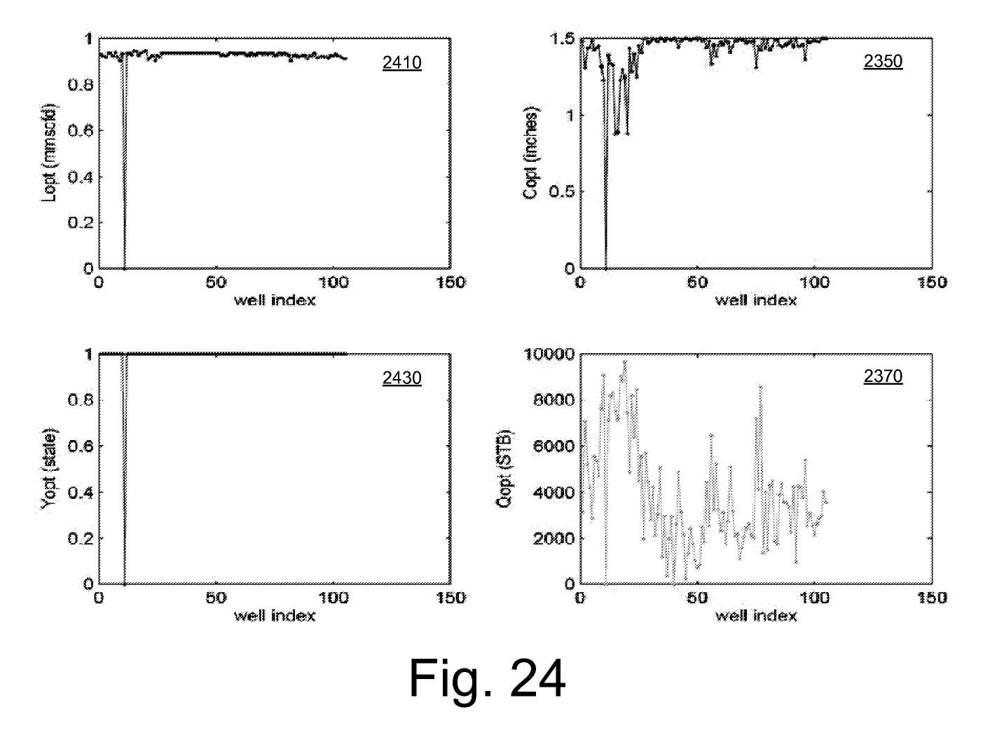

FIG. 24 shows example solution plots for Case A2 (e.g., optimize L and C with a field constraint): plot 2410 as gas-lift rates (Lₒₚₜ), plot 2430 as choke settings (Cₒₚₜ), plot 2450 as activation states (Yₒₚₜ), and plot 2470 as flowrates (Qₒₚₜ).

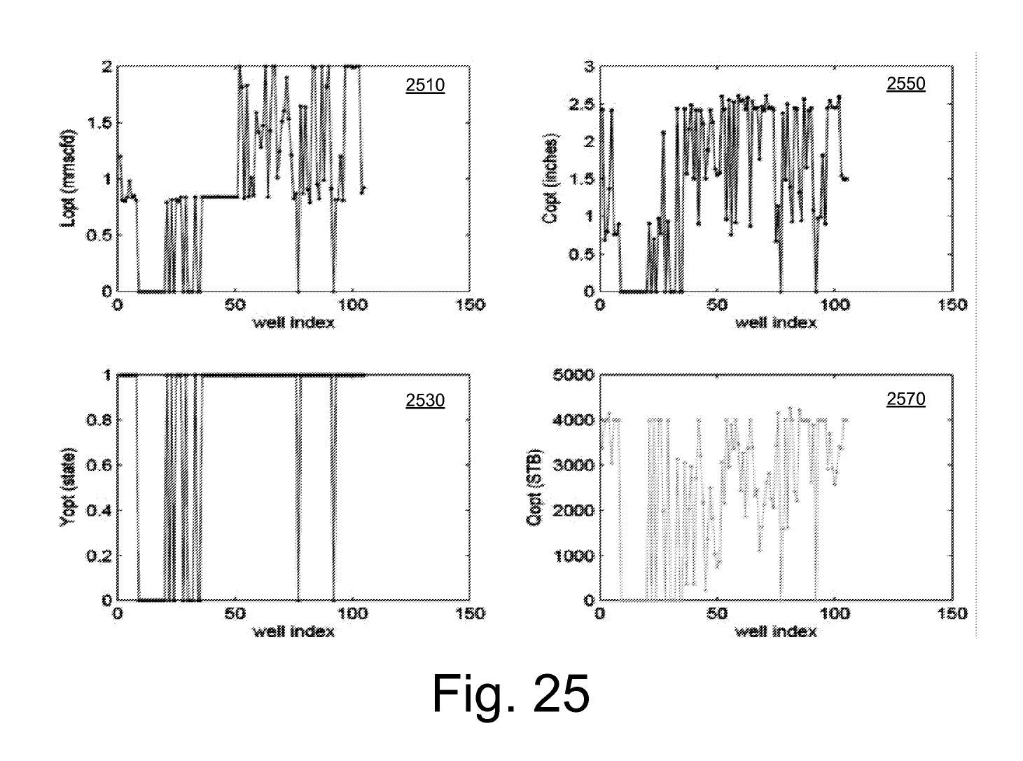

FIG. 25 shows example solution plots for Case A3 (e.g., optimize L and C with field and well constraints): plot 2510 as gas-lift rates (Lₒₚₜ), plot 2530 as choke settings (Cₒₚₜ), plot 2550 as activation states (Yₒₚₜ), and plot 2570 as flowrates (Qₒₚₜ).

As an example, a method may include generation of well production data (e.g., Q=f(L, C|P)). As an example, a method may include linear interpolation for desired operating pressure data and bilinear interpolation for production profile interpolation.

As an example, a method may include treating choke setting as either continuous or discrete over a represented surface (e.g., with appropriate mapping where desired).

As an example, a method may include stipulating a well pressure equal to a downstream pressure for an offline problem with deactivated wells. As an example, a method may include using a first non-zero pressure (e.g., for a well) from a downstream node in the event of sub-network closures or block reverse conditions arising from solution of a network simulator.

As an example, a method may include using a percentage error metric for a pressure difference norm (e.g., with less than about 1.5% difference stipulated over wells for convergence).

As an example, a method may include a GLO methodology that iterates on WHP convergence to expedite a solution (see, e.g., Table 1). As an example, a method may include using a boot-strapping procedure to manage online and offline constraint value difference. As an example, a method may include using average pressures over wells connected to a manifold (e.g., or a hub), for example, to mitigate disturbances. As an example, a method may include using an offline solution of a last iteration as a starting configuration for a subsequent iteration. As an example, a method may include using a well deactivation procedure to manage well closures for optimization and solution stability purposes.

In various examples, a formulation for an offline problem may provide for gas-lift optimization in a manner that may avoid curve modeling (e.g., fitting curves to well performance data) and storage of such modeled curves. As explained above, a bilinear interpolation scheme was demonstrated to be relatively fast and robust, including a nonlinear programming problem solution for the offline problem. Also, while choke settings could be reduced to zero to represent well activation, the following online network simulation evaluation will likely suffer, and particularly for small choke settings that may cause super-critical flow in the pipes. Thus, as an example, a minimum choke setting can be desirable for stability purposes as it may avoid very low values of the choke setting to be made in practice.

As explained, a method may include re-solving an offline problem by iteratively by deactivating wells with low choke settings and, for example, redistributing lift-gas. As demonstrated in various trials, such an approach improved convergence stability, for example, via deactivating wells in an offline problem that were shut by a network simulator in a preceding iteration.

As an example, a procedure may include domain activation to manage well activation. In such an example, a given well may operate in its desired bounds if active, or will be shut-in otherwise. Thus, in such an approach, no lift-gas is wasted or choke setting made if the well is shut. However, as a MINLP is solved due to the integer variables introduced, lack of convexity in the offline problem can impair this procedure. A bilinear procedure with cell activation, as presented in an effort to counter this concern, proved to be prohibitive for high dimension problems. As demonstrated via trials, a MILP formulation, while having some desirable properties, succumbed to the effects of dimensionality (e.g., scaling), as subject to imposed time/computing resource considerations.

As explained, of various formulations presented, a bilinear interpolation model can be beneficial for optimization of gas-lift rate and choke setting in individual wells of a production network and can provide for a solution in a relatively robust and timely manner (e.g., while also effectively accounting for well and field level constraints). Such a procedure was able to solve a real-world large dimensional problem in an acceptable time period. Further, as mentioned, a well deactivation procedure can be included as part of the offline procedure.

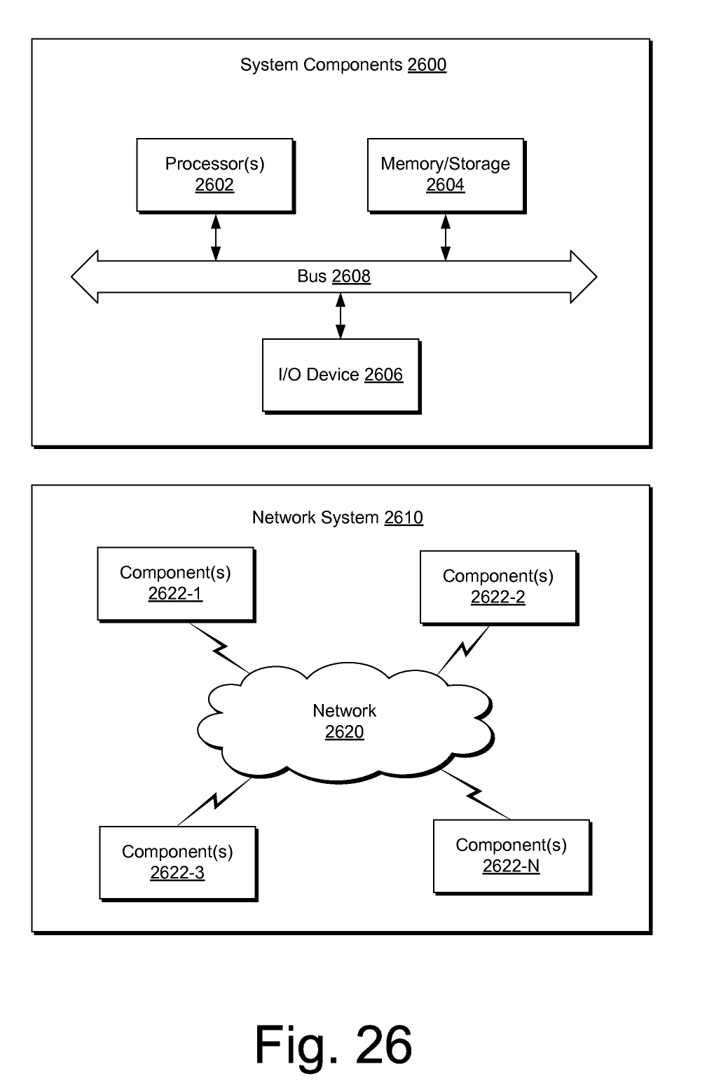

FIG. 26 shows components of a computing system 2600 and a networked system 2610. The system 2600 includes one or more processors 2602, memory and/or storage components 2604, one or more input and/or output devices 2606 and a bus 2608. As an example, instructions may be stored in one or more computer-readable media (e.g., memory/storage components 2604). Such instructions may be read by one or more processors (e.g., the processor(s) 2602) via a communication bus (e.g., the bus 2608), which may be wired or wireless. The one or more processors may execute such instructions to implement (wholly or in part) one or more attributes (e.g., as part of a method). A user may view output from and interact with a process via an I/O device (e.g., the device 2606). As an example, a computer-readable medium may be a storage component such as a physical memory storage device, for example, a chip, a chip on a package, a memory card, etc.

As an example, components may be distributed, such as in the network system 2610. The network system 2610 includes components 2622-1, 2622-2, 2622-3, . . . 2622-N. For example, the components 2622-1 may include the processor(s) 2602 while the component(s) 2622-3 may include memory accessible by the processor(s) 2602. Further, the component(s) 2602-2 may include an I/O device for display and optionally interaction with a method. The network may be or include the Internet, an intranet, a cellular network, a satellite network, etc.

### CONCLUSION

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. A method comprising:
selecting two control variables for a fluid production network;
providing data acquired from the production network, the data associated with values for the two control variables;
providing an interpolation model for interpolating the data over a domain defined by operational bounds for each of the two control variables; and
solving a programming problem based at least in part on the interpolation model to provide values for at least one of the two control variables.

2. The method of claim 1 comprising deactivating at least a portion of the fluid production network.

3. The method of claim 2 wherein the fluid production network comprises wells and wherein deactivating comprises setting one of the two control variables for at least one of wells to a deactivation value.

4. The method of claim 2 comprising optimizing fluid production in the fluid production network at least in part by the deactivating.

5. The method of claim 1 wherein the interpolation model comprises a surface defined by the two control variables.

6. The method of claim 1 wherein the two control variables comprise an acceleration control variable and a deceleration control variable.

7. The method of claim 6 wherein the acceleration control variable comprises gas-lift control variable.

8. The method of claim 6 wherein the acceleration control variable comprises a power control variable associated with a pump.

9. The method of claim 6 wherein the deceleration control variable comprises a choke control variable.

10. The method of claim 1 wherein at least one of the control variables corresponds to a continuously adjustable control variable for a piece of equipment in the fluid production network.

11. The method of claim 1 wherein the two control variables comprise a gas-lift control variable and a choke control variable.

12. The method of claim 1 comprising an offline method, offline from the fluid production network.

13. The method of claim 12 comprising one or more online actions associated with the values for at least one of the two control variables for controlling production of fluid from the fluid production network.

14. The method of claim 1 wherein the programming problem comprises a problem selected from a group consisting of a nonlinear programming problem, a mixed-integer nonlinear programming problem and a mixed-integer programming problem.

15. A system comprising:
a field controller that comprises data acquisition instructions;
a field network that comprises equipment controllable by the field controller; and
a modeler that comprises offline instructions and online instructions wherein the offline instructions comprises instructions for an interpolation model for modeling data acquired by the field controller for at least two control variables for equipment controllable by the field controller.

16. The system of claim 15 comprising one or more processors and memory to store instructions, the instructions executable by at least one of the one or more processors.

17. The system of claim 15 wherein the field network comprises chokes and gas-lift equipment.

18. One or more computer-readable media comprising computer-executable instructions to instruct a computer to:
solve a programming problem based in part on an interpolation model for data of a fluid production network with respect to control variables of the fluid production network to provide values for at least one of the control variables of the fluid production network.

19. The one or more computer-readable media of claim 18 wherein the control variables comprise an acceleration control variable and a deceleration control variable.

20. The one or more computer-readable media of claim 19 wherein the acceleration control variable comprises a gas-lift control variable and wherein the deceleration control variable comprises a choke control variable.
